(19) United States
(12) Patent Application Publication
(10) Pub. No.: US 2016/0205335 A1
(43) Pub. Date: Jul. 14, 2016

(54) SOLID-STATE IMAGING DEVICE

(71) Applicant: Kabushiki Kaisha Toshiba, Tokyo (JP)

(72) Inventors: Kazuhiro HIWADA, Yokohama Kanagawa (JP); Yukiyasu TATSUZAWA, Yokohama Kanagawa (JP); Tatsuji ASHITANI, Yokohama Kanagawa (JP)

(21) Appl. No.: 14/717,244

(22) Filed: May 20, 2015

(30) Foreign Application Priority Data
Jan. 14, 2015 (JP) 2015-005263

(51) Int. Cl. H04N 5/374

(52) U.S. Cl. CPC H04N 5/374

(57) ABSTRACT

According to one embodiment, a solid-state imaging device includes a pixel array, a scanning circuit, signal lines, processing circuits, and connection parts. One processing circuit and the signal lines are provided per one pixel column of the pixel array. The signal lines include a first signal line and a second signal line. Each pixel column includes first pixels and second pixels. The first pixels are configured to output pixel signals to the first signal line. The second pixels are configured to output pixel signals to the second signal line. When the scanning circuit simultaneously selects a first pixel row and a second pixel row, the connection parts connect the first signal line and the second signal line of each pixel column to different processing circuits. The first pixel row includes the first pixels. The second pixel row includes the second pixels.

### CROSS-REFERENCE TO RELATED APPLICATIONS

This application is based upon and claims the benefit of priority from Japanese Patent Application No. 2015-5263, filed on Jan. 14, 2015; the entire contents of which are incorporated herein by reference.

### FIELD

Embodiments described herein relate generally to a solid-state imaging device.

### BACKGROUND

Conventionally, there is proposed a technique for high-speed imaging in solid-state imaging devices. In the high-speed imaging, the solid-state imaging devices are required to be able to perform imaging with excellent sensitivity and to obtain images with high quality.

### BRIEF DESCRIPTION OF THE DRAWINGS

FIG. 1 is a block diagram showing a configuration of a solid-state imaging device according to a first embodiment;

FIG. 2 is a block diagram showing a configuration of a camera system equipped with the solid-state imaging device shown in FIG. 1;

FIG. 3 is a view showing a schematic configuration of a pixel array shown in FIG. 1;

FIG. 4 is a view for explaining an operation of the solid-state imaging device in a first imaging mode according to the first embodiment;

FIG. 5 is a view for explaining an operation of the solid-state imaging device in a second imaging mode according to the first embodiment;

FIG. 6 is a view showing a schematic configuration of a pixel array provided in a solid-state imaging device according to a second embodiment;

FIG. 7 is a view for explaining an operation of the solid-state imaging device in a first imaging mode according to the second embodiment;

FIG. 8 is a view for explaining timings at which pixel signals are read from an image sensor in the first imaging mode according to the second embodiment;

FIG. 9 is a view for explaining a course of pixel signals being read from the image sensor in respective horizontal read periods shown in FIG. 8;

FIG. 10 is a view for explaining an operation of the solid-state imaging device in a second imaging mode according to the second embodiment;

FIG. 11 is a view for explaining timings at which pixel signals are read from the image sensor in the second imaging mode according to the second embodiment;

FIG. 12 is a view for explaining a course of pixel signals being read from the image sensor in respective horizontal read periods shown in FIG. 11;

FIG. 13 is a view for explaining a modification according to the second embodiment;

FIG. 14 is a block diagram showing a configuration of a solid-state imaging device according to a third embodiment;

FIG. 15 is a view for explaining a thinning process in a third imaging mode according to the third embodiment;

FIG. 16 is a view for explaining an operation of the solid-state imaging device in the first frame period shown in FIG. 15;

FIG. 17 is a view for explaining an operation of the solid-state imaging device in the second frame period shown in FIG. 15;

FIG. 18 is a view for explaining an operation of the solid-state imaging device in the third frame period shown in FIG. 15;

FIG. 19 is a view for explaining an operation of the solid-state imaging device in the fourth frame period shown in FIG. 15;

FIG. 20 is a view showing a schematic configuration of a pixel array provided in a solid-state imaging device according to a fourth embodiment;

FIG. 21 is a view for explaining a thinning process in a first imaging mode according to the fourth embodiment;

FIG. 22 is a view for explaining an operation of the solid-state imaging device in the first frame period shown in FIG. 21;

FIG. 23 is a view for explaining an operation of the solid-state imaging device in the second frame period shown in FIG. 21;

FIG. 24 is a view for explaining an operation of the solid-state imaging device in the third frame period shown in FIG. 21;

FIG. 25 is a view for explaining an operation of the solid-state imaging device in the fourth frame period shown in FIG. 21;

FIG. 26 is a view for explaining an operation of the solid-state imaging device in a second imaging mode according to the fourth embodiment;

FIG. 27 is a block diagram showing a configuration of a solid-state imaging device according to a fifth embodiment;

FIG. 28 is a view for explaining an operation of the solid-state imaging device in the first frame period included in a third imaging mode according to the fifth embodiment;

FIG. 29 is a view for explaining an operation of the solid-state imaging device in the second frame period included in the third imaging mode according to the fifth embodiment;

FIG. 30 is a view for explaining image data obtained by an operation of the solid-state imaging device in the third imaging mode shown in FIGS. 28 and 29;

FIG. 31 is a view for explaining first to fourth methods of a reconstruction process performed by a reconstruction processing part shown in FIG. 27; and

FIG. 32 is a view for explaining a fifth method of a reconstruction process performed by a reconstruction processing part shown in FIG. 27.

### DETAILED DESCRIPTION

In general, according to one embodiment, a solid-state imaging device includes a pixel array, a scanning circuit, signal lines, processing circuits, and connection parts. The pixel array is composed of pixels arrayed in a matrix format. Each pixel includes a photoelectric conversion element. The scanning circuit is configured to supply a drive signal to pixels of a selected pixel row. The drive signal is a signal for reading a pixel signal based on a signal charge accumulated in a pixel. The signal lines are configured to transmit pixel signals read in response to the drive signal. The processing circuits are configured to process the transmitted pixel signals. The connection parts are configured to connect the signal lines to the processing circuits. One of the processing circuits and the signal lines are provided per one pixel column of the pixel array. The signal lines include a first signal line and a second signal line. Each pixel column includes first pixels and second pixels. The first pixels are configured to output pixel signals to the first signal line. The second pixels are configured to output pixel signals to the second signal line. When the scanning circuit simultaneously selects a first pixel row and a second pixel row, the connection parts connect the first signal line and the second signal line of each pixel column to processing circuits different from each other. The first pixel row includes the first pixels. The second pixel row includes the second pixels.

Exemplary embodiments of a solid-state imaging device will be explained below in detail with reference to the accompanying drawings. The present invention is not limited to the following embodiments.

### First Embodiment

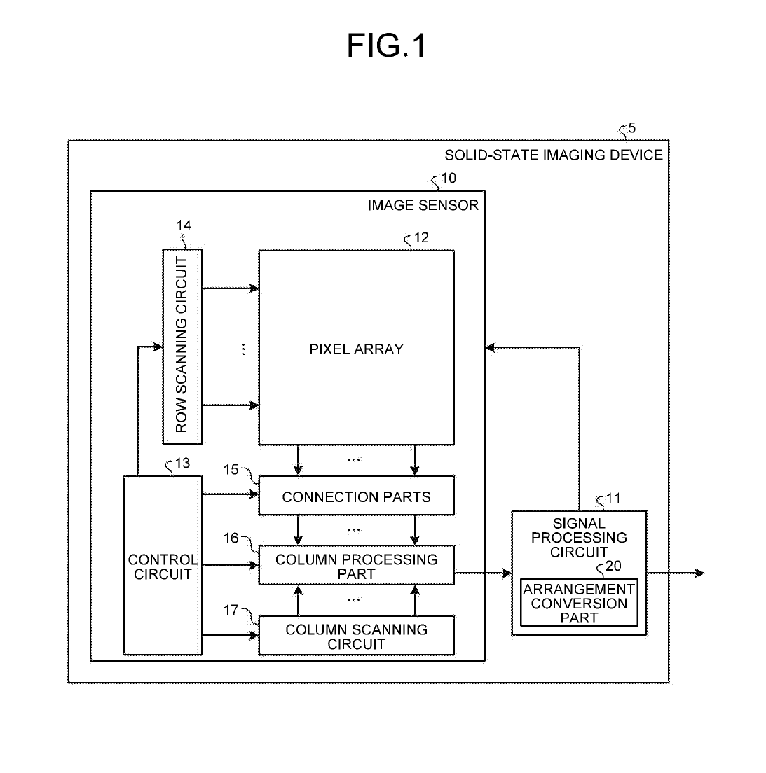

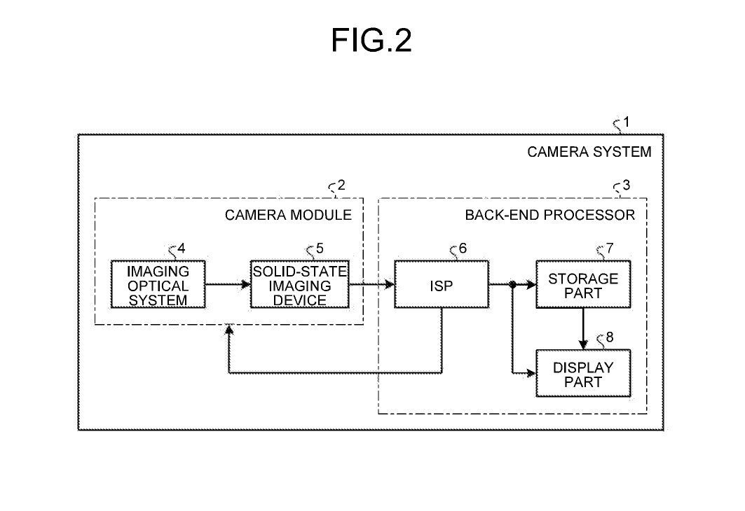

FIG. 1 is a block diagram showing a configuration of a solid-state imaging device according to a first embodiment. FIG. 2 is a block diagram showing a configuration of a camera system equipped with the solid-state imaging device shown in FIG. 1.

The camera system 1 is an electronic apparatus including a camera module 2. The camera system 1 is a digital video camera, for example. The camera, system 1 may be an electronic apparatus, such as a digital still camera or a mobile terminal apparatus with a camera.

The camera system 1 includes the camera module 2 and a back-end processor 3. The camera module 2 includes an imaging optical system 4 and a solid-state imaging device 5. The back-end processor 3 includes an image signal processor (ISP) 6, a storage part 7, and a display part 8.

The imaging optical system 4 takes in light from an object. The imaging optical system 4 includes a lens for condensing light to an object image. The solid-state imaging device 5 images the object image. The ISP 6 performs a signal process to the image signal obtained by the imaging in the solid-state imaging device 5. The storage part 7 stores the image subjected to the signal process by the ISP 6. The storage part 7 outputs an image signal to the display part 8, in response to user operations or the like.

The display part 8 displays an image, in accordance with an image signal input from the ISP 6 or storage part 7. The display part 8 is formed of a liquid crystal display, for example. The camera system 1 performs feedback control to the camera module 2, based on data subjected to a signal process by the ISP 6.

The solid-state imaging device 5 includes an image sensor 10 and a signal processing circuit 11. The image sensor 10 images an object image. The image sensor 10 is formed of a CMOS image sensor. The image sensor 10 includes a pixel array 12, a control circuit 13, a row scanning circuit 14, connection parts 15, a column processing part 16, and a column scanning circuit 17. The pixel array 12, the control circuit 13, the row scanning circuit 14, the connection parts 15, the column processing part 16, and the column scanning circuit 17 are mounted on a single chip.

The pixel array 12 is composed of pixels arrayed in a matrix format. Each pixel includes a photo diode serving as a photoelectric conversion element. The photoelectric conversion element generates a signal charge corresponding to incident light quantity. Each pixel accumulates the signal charge generated in accordance with incident light quantity. The pixel array 12 is provided with color filters on the incident side. The pixel array 12 is composed of a plurality of color pixels for detecting light of colors different from each other, which are arranged in a regular array. In this embodiment, the plurality of color pixels are arranged to form a Bayer array.

The control circuit 13 generates pulse signals for controlling various kinds of timing. The control circuit 13 supplies a pulse signal corresponding to a vertical synchronous signal to the row scanning circuit 14. The control circuit 13 supplies a pulse signal corresponding to a horizontal synchronous signal to the column scanning circuit 17. The control circuit 13 supplies pulse signals indicative of drive timing respectively to the connection parts 15 and the column processing part 16.

The row scanning circuit 14 serving as a first scanning circuit selects a pixel row to read pixel signals therefrom, in response to a pulse signal from the control circuit 13. Each pixel row is composed of pixels arrayed in the row direction (horizontal direction). The row scanning circuit 14 supplies a drive signal for reading pixel signals generated in accordance with incident light quantity, to the pixels of a selected pixel row. The row scanning circuit 14 includes a shift register and an address decoder. The pixel signals read in response to the drive signal are transmitted to the connection parts 15 through vertical signal lines. The connection parts 15 connect the vertical signal lines to the column processing part 16. The connection parts 15 include a connection part configured to connect a signal line to a processing circuit. The connection parts 15 will be described later in detail.

The column processing part 16 includes a plurality of processing circuits. The processing circuits are respectively provided for the pixel columns. The processing circuits are respectively configured to process pixel signals transmitted through the vertical signal lines. The column processing part 16 performs a signal process to the pixel signals transmitted through the vertical signal lines, by use of the respective processing circuits. Each processing circuit performs a correlative double sampling process (CDS), which is for reducing fixed pattern noises, to pixel signals. Further, each processing circuit performs AD conversion to pixel signals. Each processing circuit may be designed to perform a signal process other than the CDS and the AD conversion. The column processing part 16 holds each of the pixel signals subjected to the signal process respectively by the processing circuits.

The column scanning circuit 17 serving as a second scanning circuit sequentially selects the processing circuits of column processing part 16, in response to a pulse signal from the control circuit 13. The column processing part 16 sequentially outputs the pixel signals held by the respective processing circuits, in response to selective scanning by the column scanning circuit 17. The image sensor 10 outputs an image signal containing pixel signals as components, from the column processing part 16.

The signal processing circuit 11 can perform various kinds of signal processes to an image signal input from the image sensor 10. The signal processing circuit 11 is mounted on a chip common to the image sensor 10. The signal processing circuit 11 includes an arrangement conversion part 20.

The arrangement conversion part 20 converts the arrangement of signal components corresponding to the respective pixels in an image signal from the image sensor 10, in accordance with a predetermined rule. The arrangement conversion part 20 converts the component arrangement order in the image signal, in accordance with the pixel arrangement in the pixel array 12. The arrangement conversion part 20 includes a line memory, such as an SRAM, which is configured to hold an image signal from one pixel row.

Other than the arrangement conversion in the arrangement conversion part 20, the signal processing circuit 11 can perform gamma correction, noise reduction process, lens shading correction, white balance adjustment, distortion correction, and resolution restoration. FIG. 1 does not show the configurations other than the arrangement conversion part 20, included in the signal processing circuit 11.

The solid-state imaging device 5 outputs an image signal subjected to a signal process by the signal processing circuit 11 to the outside of the chip. The solid-state imaging device 5 performs feedback control to the image sensor 10, based on data derived from a signal process by the signal processing circuit 11.

The camera system 1 may be designed such that the ISP 6 of the back-end processor 3 can perform at least any one of the various kinds of signal processes mentioned above as being performed by the signal processing circuit 11 in this embodiment. Alternatively, the camera system 1 may be designed such that both of the signal processing circuit 11 and the ISP 6 can perform at least any one of the various kinds of signal processes. The signal processing circuit 11 and the ISP 6 may be designed to perform a signal process other than the signal processes described in this embodiment. The function of the arrangement conversion part 20 may be provided in the ISP 6 in place of the signal processing circuit 11.

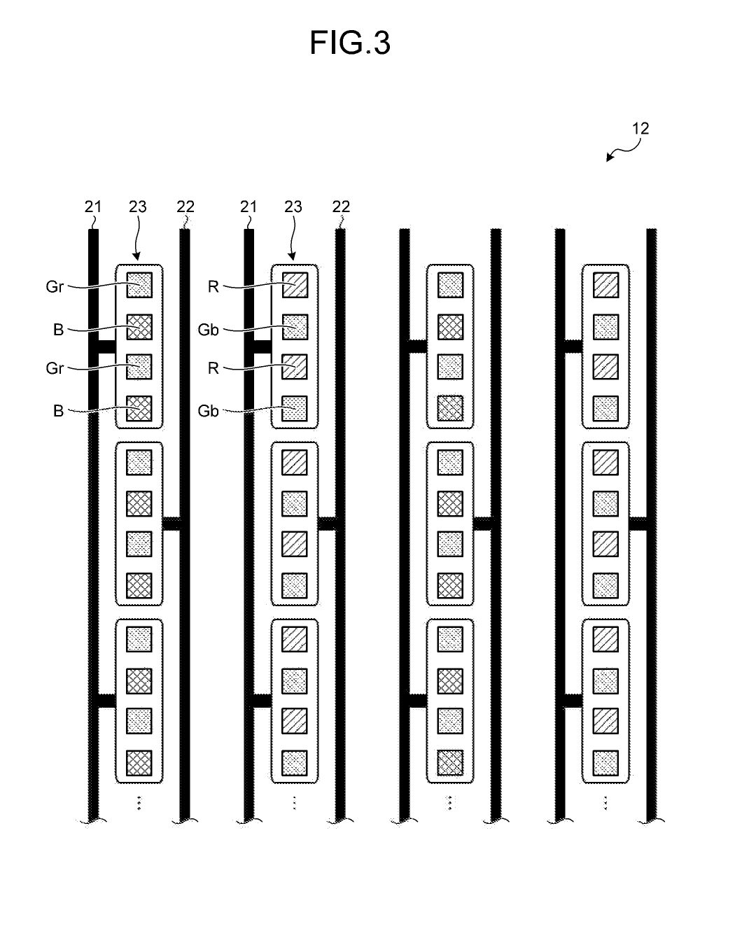

FIG. 3 is a view showing a schematic configuration of the pixel array shown in FIG. 1. The Bayer array is defined by use of a 2×2 pixel block as a unit. In this pixel block, a red (R) pixel and a blue (B) pixel are arranged at diagonal positions, and two green (G) pixels are arranged at the other diagonal positions. Of the two G pixels included in the pixel block, the G pixel adjacent to the R pixel in the row direction will be referred to as “Gr pixel”. Of the two G pixels included in the pixel block, the G pixel adjacent to the B pixel in the row direction will be referred to as “Gb pixel”.

In the pixel array 12, two vertical signal lines 21 and 22 are provided for each pixel column composed of pixels arrayed in the column direction (vertical direction) One processing circuit described later and first and second signal lines are provided per one pixel column of the pixel array 12. The pixel array 12 outputs pixel signals from each pixel cell 23 to either one of the vertical signal lines 21 and 22. Each pixel cell 23 includes a plurality of pixels. In the first embodiment, each pixel cell 23 is composed of four pixels arrayed in the column direction.

The four pixels forming each pixel cell 23 share a MOS transistor serving as a component of the pixels. This pixel sharing structure according to the first embodiment will be referred to as “4V1H pixel sharing structure” in the explanation hereinafter. For example, the four pixels forming each pixel cell 23 share a transfer transistor formed of a MOS transistor, a floating diffusion region (FD), a reset transistor, an amplification transistor, and a row selection transistor.

Each pixel cell 23 includes four photo diodes (PDs) each serving as a photoelectric conversion element. Each PD generates a signal charge corresponding to incident light quantity. The transfer transistor transfers the signal charge from each PD to the FD, in response to a read signal serving as a drive signal from the row scanning circuit 14. The FD converts the signal charge transferred by the transfer transistor into an electric potential. The amplification transistor amplifies an electric potential change made by the FD, and thereby forms a pixel signal. The reset transistor removes the charge of the FD, and thereby initializes the electric potential of the FD to a certain level, in response to a reset signal serving as a drive signal from the row scanning circuit 14.

By including the pixel sharing structure, the image sensor 10 can reduce the pixel pitch, as compared with a case where a MOS transistor is provided for each pixel. The pixel sharing structure is suitable for downsizing of the image sensor 10. With the pixel sharing structure thus arranged, the solid-state imaging device 5 can increase the saturation charge amount, improve the sensitivity, and reduce the random noise.

The pixel cells 23 arrayed in the column direction include first pixel cells connected to the vertical signal line 21 serving as a first signal line. The respective pixels of each first pixel cell are first pixels configured to output pixel signals to the vertical signal line 21. The pixel cells 23 arrayed in the column direction include second pixel cells connected to the vertical signal line 22 serving as a second signal line. The respective pixels of each second pixel cell are second pixels configured to output pixel signals to the vertical signal line 22. In each column, the first pixel cell and the second pixel cell are alternately disposed in the column direction. Thus, each pixel column includes first pixels and second pixels.

The pixel array 12 includes BGr pixel cells and RGb pixel cells. Each BGr pixel cell is a pixel cell 23 composed of two Gr pixels and two B pixels. Each RGb pixel cell is a pixel cell 23 composed of two R pixels and two Gb pixels. In the pixel array 12, a column composed of BGr pixel cells and a column composed of RGb pixel cells are alternately disposed in the row direction.

The solid-state imaging device 5 is supposed to be able to perform imaging in a plurality of imaging modes. For example, the ISP 6 generates a mode selection signal, in response to a user operation to the camera system 1. The solid-state imaging device 5 switches the imaging modes, in response to a mode selection signal input from the ISP 6. The control circuit 13 switches the control over the respective portions of the image sensor 10, in response to a mode selection signal.

In the first embodiment, the solid-state imaging device 5 is supposed to be able to switch the imaging modes between a first imaging mode and a second imaging mode. In the first imaging mode, the solid-state imaging device 5 performs a binning process that simultaneously reads pixel signals from a plurality of pixels. In the binning process in the first imaging mode, each of the data amount in the row direction and the data amount in the column direction is made in half, relative to the number of effective pixels in the pixel array 12. In the second imaging mode, the solid-state imaging device 5 stops the binning process. In the second imaging mode, the solid-state imaging device 5 sequentially reads pixel signals from the pixels in each row and each column of the pixel array 12.

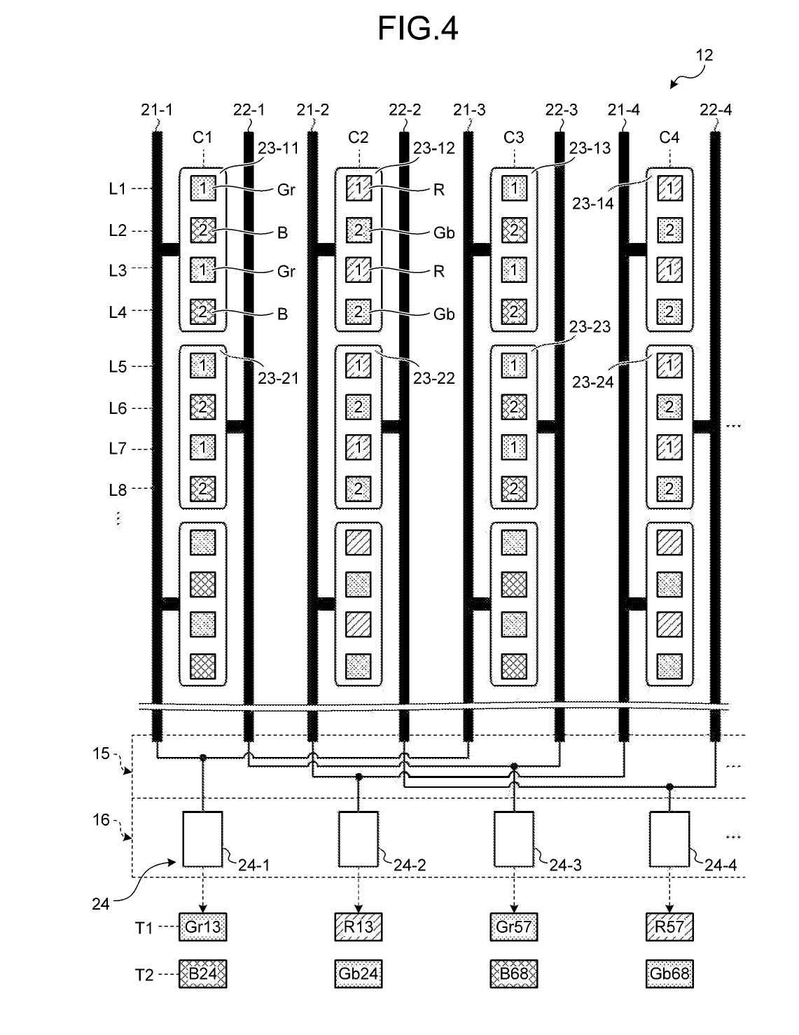

FIG. 4 is a view for explaining an operation of the solid-state imaging device in the first imaging mode according to the first embodiment. The solid-state imaging device 5 performs 2×2 binning that simultaneously reads pixel signals in relation to two pixels in the row direction and two pixels in the column direction.

The column processing part 16 includes processing circuits 24 (24-1, 24-2, - - - ) respectively provided for the pixel columns. The number of the processing circuits 24 included in the column processing part 16 is the same as the number of pixel columns in the pixel array 12. Processing circuits 24-1 to 24-4 are respectively provided for pixel columns C1 to C4. Each of the pixel columns C1 and C3 is a pixel column composed of Gr pixels and B pixels. Each of the pixel columns C2 and C4 is a pixel column composed of R pixels and Gb pixels.

A vertical signal line 21-1 is connected to each first pixel cell in the pixel column C1. A vertical signal line 21-2 is connected to each first pixel cell in the pixel column C2. A vertical signal line 21-3 is connected to each first pixel cell in the pixel column C3. A vertical signal line 21-4 is connected to each first pixel cell in the pixel column C4.

A vertical signal line 22-1 is connected to each second pixel cell in the pixel column C1. A vertical signal line 22-2 is connected to each second pixel cell in the pixel column C2. A vertical signal line 22-3 is connected to each second pixel cell in the pixel column C3. A vertical signal line 22-4 is connected to each second pixel cell in the pixel column C4.

The connection parts 15 connect the vertical signal lines 21 (21-1, 21-2, - - - ) and 22 (22-1, 22-2 - - - ) to the processing circuits 24. In the first imaging mode, the connection parts 15 are set in a first connection state. The first connection state includes short-circuiting between two vertical signal lines (21-1 and 21-3, 21-2 and 21-4, - - - ) serving as first signal lines, and short-circuiting between two vertical signal lines (22-1 and 22-3, 22-2 and 22-4, - - - ) serving as second signal lines.

When a mode selection signal for setting the imaging mode to the first imaging mode is input into the control circuit 13, the control circuit 13 outputs a control signal corresponding to the first imaging mode to the connection parts 15. In response to the control signal from the control circuit 13, the connection parts 15 come into the first connection state shown in FIG. 4.

The connection parts 15 connect the vertical signal lines 21-1 and 22-1 for the pixel column C1 respectively to the processing circuits 24-1 and 24-3. In the first imaging mode, the connection parts 15 connect the first signal line and the second signal line for each pixel column respectively to different ones of the processing circuits 24.

Also for the pixel columns other than the pixel columns C1 to C4, the connection parts 15 form the same connection state in association with each set of four pixel columns, as formed for the pixel columns C1 to C4. As long as the first imaging mode is set as the imaging mode, the connection parts 15 keep the connection state between the vertical signal lines 21 and 22 and the processing circuits 24.

In the first imaging mode, the control circuit 13 supplies a pulse signal for simultaneously selecting four pixel rows to the row scanning circuit 14. The row scanning circuit 14 simultaneously selects the four pixel rows, in response to the pulse signal from the control circuit 13. The four pixel rows thus selected are respectively positioned with one pixel row interposed therebetween.

The row scanning circuit 14 supplies a drive signal to the pixels of the selected four pixel rows. The row scanning circuit 14 performs selective scanning that sequentially shifts the selection targets formed of four pixel rows in the column direction. In the first imaging mode, the row scanning circuit 14 simultaneously selects two first pixel rows and two second pixel rows. Each of these first pixel rows is a pixel row including first pixels. Each of these second pixel rows is a pixel row including second pixels.

The row scanning circuit 14 supplies a drive signal to the pixel rows L1, L3, L5, and L7 at a certain timing during a frame period. The row scanning circuit 14 supplies a drive signal to the pixel rows L2, L4, L6, and L8 after it finishes the supply of the drive signal to the pixel rows L1, L3, L5, and L7. Similarly, for the remaining pixel rows, the row scanning circuit 14 sequentially performs such selection of four pixel rows each time and supplies a drive signal to them.

The pixel rows L1, L3, L5, L7, - - - odd-numbered from the top in FIG. 4 are pixel columns composed of Gr pixels and R pixels. The pixel rows L2, L4, L6, L8, - - - even-numbered from the top in FIG. 4 are pixel columns composed of B pixels and Gb pixels. Each of the pixel rows L1 to L4 is a first pixel row. Each of the pixel rows L5 to L8 is a second pixel row.

The connection parts 15 include a connection part to connect the vertical signal lines 21-1 and 21-3 to the processing circuit 24-1. The vertical signal line 21-1 is provided for the pixel column C1 serving as a first pixel column. The vertical signal line 21-3 is provided for the pixel column C3 serving as a second pixel column. The processing circuit 24-1 serves as a first processing circuit. The connection parts 15 include a connection part to connect the vertical signal lines 22-1 and 22-3 to the processing circuit 24-3. The vertical signal line 22-1 is provided for the pixel column C1. The vertical signal line 22-3 is provided for the pixel column C3. The processing circuit 24-3 serves as a second processing circuit.

When a drive signal is simultaneously supplied to the pixel rows L1 and L3, signals are simultaneously read from the two Gr pixels in the pixel cell 23-11 of the pixel column C1. The pixel cell 23-11 outputs a pixel signal made by adding up the charges from the two Gr pixels, to the vertical signal line 21-1. The pixel cell 23-13 of the pixel column C3 outputs a pixel signal made by adding up the charges from the two Gr pixels, to the vertical signal line 21-3.

The pixel signal output from the pixel cell 23-11 to the vertical signal line 21-1 and the pixel signal output from the pixel cell 23-13 to the vertical signal line 21-3 are input into the processing circuit 24-1. The voltages of the pixel signals input into the processing circuit 24-1 are averaged between them. Consequently, the processing circuit 24-1 obtains a pixel signal derived from the four Gr pixels included in the two pixel cells 23-11 and 23-13.

The connection parts 15 include a connection part to connect the vertical signal lines 21-2 and 21-4 to the processing circuit 24-2. The vertical signal line 21-2 is provided for the pixel column C2 serving as a first pixel column. The vertical signal line 21-4 is provided for the pixel column C4 serving as a second pixel column. The processing circuit 24-2 serves as a first processing circuit. The connection parts 15 include a connection part to connect the vertical signal lines 22-2 and 22-4 to the processing circuit 24-4. The vertical signal line 22-2 is provided for the pixel column C2. The vertical signal line 22-4 is provided for the pixel column C4. The processing circuit 24-4 serves as a second processing circuit.

The pixel cell 23-12 of the pixel column C2 outputs a pixel signal made by adding up the charges from the two R pixels, to the vertical signal line 21-2. The pixel cell 23-14 of the pixel column C4 outputs a pixel signal made by adding up the charges from the two R pixels, to the vertical signal line 21-4. The voltages of the pixel signals from the vertical signal lines 21-2 and 21-4 are averaged between them by the processing circuit 24-2. Consequently, the processing circuit 24-2 obtains a pixel signal derived from the four R pixels included in the two pixel cells 23-12 and 23-14.

Further, when a drive signal is simultaneously supplied to the pixel rows L5 and L7, the pixel cell 23-21 outputs a pixel signal made by adding up the charges from the two Gr pixels, to the vertical signal line 22-1. The pixel cell 23-23 outputs a pixel signal made by adding up the charges from the two Gr pixels, to the vertical signal line 22-3. The processing circuit 24-3 obtains a pixel signal derived from the four Gr pixels included in the two pixel cells 23-21 and 23-23.

The pixel cell 23-22 outputs a pixel signal made by adding up the charges from the two R pixels, to the vertical signal line 22-2. The pixel cell 23-24 outputs a pixel signal made by adding up the charges from the two R pixels, to the vertical signal line 22-4. The processing circuit 24-4 obtains a pixel signal derived from the four R pixels included in the two pixel cells 23-22 and 23-24.

The processing circuits 24-1 to 24-4 respectively process pixel signals input from the connection parts 15. The processing circuits 24-1 to 24-4 sequentially output the processed pixel signals, in response to selective scanning by the column scanning circuit 17 in a horizontal read period T1. In the horizontal read period T1, the image sensor 10 outputs an image signal containing information detected by the respective pixels denoted with “1” in FIG. 4.

Of the image signal read from the image sensor 10 in the horizontal read period T1, a signal component Gr13 processed by the processing circuit 24-1 corresponds to pixel signals detected by the four Gr pixels “1” positioned in the pixel rows L1 and L3. A signal component R13 processed by the processing circuit 24-2 corresponds to pixel signals detected by the four R pixels “1” positioned in the pixel rows L1 and L3. The signal components Gr13 and R13 are signal components obtained by first pixels.

A signal component Gr57 processed by the processing circuit 24-3 corresponds to pixel signals detected by the four Gr pixels “1” positioned in the pixel rows L5 and L7. A signal component R57 processed by the processing circuit 24-4 corresponds to pixel signals detected by the four R pixels “1” positioned in the pixel rows L5 and L7. The signal components Gr57 and R57 are signal components obtained by second pixels. In the horizontal read period T1, the arrangement conversion part 20 holds the image signal read from the image sensor 10.

In a horizontal read period T2 next, a drive signal is simultaneously supplied to the pixel rows L2, L4, L6, and L8 in the pixel array 12. The processing circuit 24-1 obtains a pixel signal derived from the four B pixels included in the two pixel cells 23-11 and 23-13. The processing circuit 24-2 obtains a pixel signal derived from the four Gb pixels included in the two pixel cells 23-12 and 23-14.

The processing circuit 24-3 obtains a pixel signal derived from the four B pixels included in the two pixel cells 23-21 and 23-23. The processing circuit 24-4 obtains a pixel signal derived from the four Gb pixels included in the two pixel cells 23-22 and 23-24.

The processing circuits 24-1 to 24-4 sequentially output the processed pixel signals, in response to selective scanning by the column scanning circuit 17 in the horizontal read period T2. In the horizontal read period T2, the image sensor 10 outputs an image signal containing information detected by the respective pixels denoted with “2” in FIG. 4.

Of the image signal read from the image sensor 10 in the horizontal read period T2, a signal component B24 processed by the processing circuit 24-1 corresponds to pixel signals detected by the four B pixels “2” positioned in the pixel rows L2 and L4. A signal component Gb24 processed by the processing circuit 24-2 corresponds to pixel signals detected by the four Gb pixels “2” positioned in the pixel rows L2 and L4. The signal components B24 and Gb24 are signal components obtained by first pixels.

A signal component B68 processed by the processing circuit 24-3 corresponds to pixel signals detected by the four B pixels “2” positioned in the pixel rows L6 and L8. A signal component Gb68 processed by the processing circuit 24-4 corresponds to pixel signals detected by the four Gb pixels “2” positioned in the pixel rows L6 and L8. The signal components B68 and Gb68 are signal components obtained by second pixels. In the horizontal read period T2, the image signal read from the image sensor 10 is input into the arrangement conversion part 20.

The solid-state imaging device 5 reads pixel signals in the pixel array 12 shown in FIG. 4, in accordance with an order rule of from left to right in the row direction and of from top to bottom in the column direction. The arrangement conversion part 20 converts the arrangement of signal components of an image signal, so that the arrangement of signal components from respective pixels matches the pixel arrangement order in the pixel array 12.

In the horizontal read periods T1 and T2, the first pixel signal components B24 and Gb24 are read after the second pixel signal components Gr57 and R57. The arrangement conversion part 20 replaces “the signal components B24 and Gb24” and “the signal components Gr57 and R57” with each other. The arrangement conversion part 20 replaces the first pixel signal components and the second pixel signal components, which are read in the two horizontal read periods, with each other. The arrangement conversion part 20 performs this replacement to cause the arrangement of signal components to match the pixel arrangement order in the pixel array 12.

Also for the pixel columns other than the pixel columns C1 and C4, the arrangement conversion part 20 converts the arrangement of signal components of the image signal, in the same way as performed for the pixel columns C1 and C4. By performing this replacement by use of the arrangement conversion part 20, the solid-state imaging device 5 can obtain an image signal such that its information order of respective pixels matches the pixel arrangement in the pixel array 12.

Also for the remaining pixel rows following the pixel rows L1 to L8, the solid-state imaging device 5 performs the same operation as performed for the pixel rows L1 to L8. The solid-state imaging device 5 performs the 2×2 binning, and thereby reduces the data amount of an image signal in half, in each of the column direction and the row direction. By reducing the data amount of each image signal read from the image sensor 10, the solid-state imaging device 5 can perform high-speed imaging.

The solid-state imaging device 5 can realize high-speed read of pixel signals, without forming a configuration using processing circuits 24 doubled relative to the pixel columns. Thus, the solid-state imaging device 5 can make the circuit scale more compact, as compared with a case where it has a configuration using processing circuits 24 doubled.

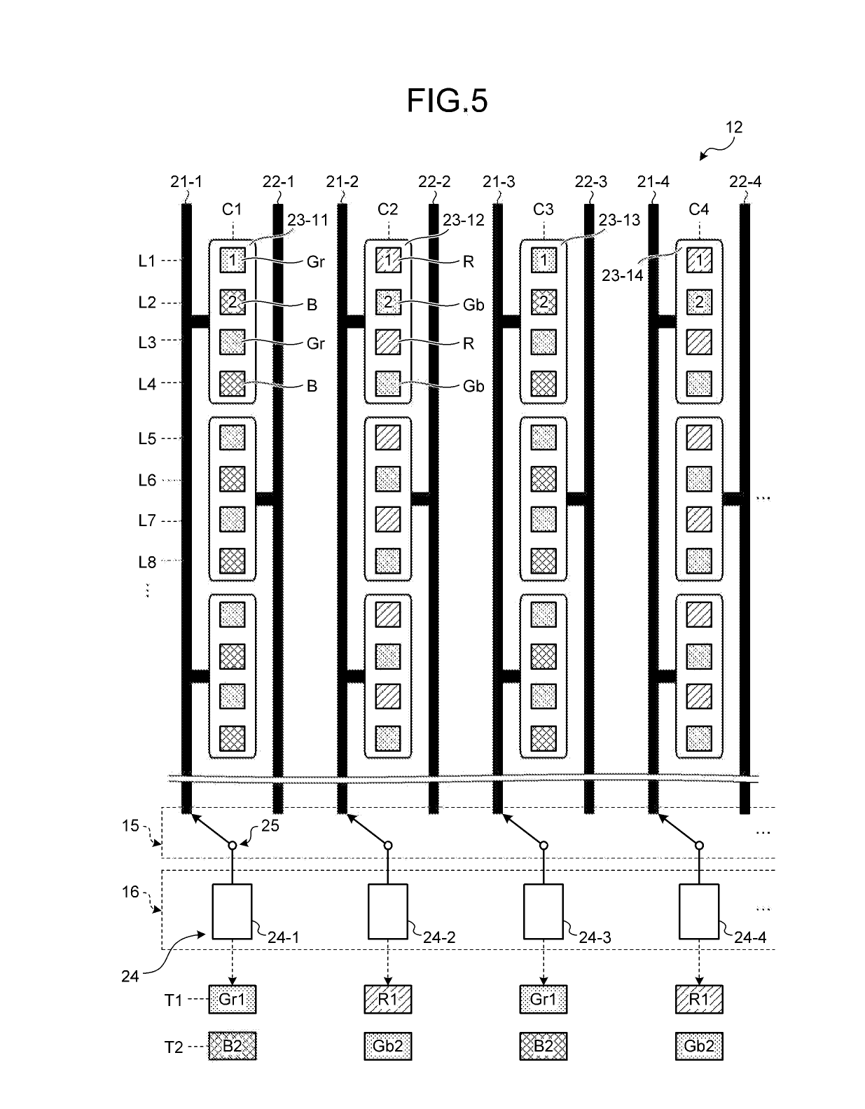

FIG. 5 is a view for explaining an operation of the solid-state imaging device in a second imaging mode according to the first embodiment. In the second imaging mode, the solid-state imaging device 5 does not perform either of the charge-adding and the voltage-averaging in association with signal components from a plurality of pixels, but sequentially reads signal components from the respective pixels of the pixel array 12. In the second imaging mode, the connection parts 15 come into a connection state that includes switches 25 respectively provided for the processing circuits 24. The switch 25 serves as a connection part configured to connect a signal line to a processing circuit.

When a mode selection signal for setting the imaging mode to the second imaging mode is input into the control circuit 13, the control circuit 13 outputs a control signal corresponding to the second imaging mode to the connection parts 15. In response to the control signal from the control circuit 13, the connection parts 15 come into a second connection state. FIG. 5 shows the connection parts 15 in one of the situations in the second connection state.

As shown in FIG. 5, the connection parts 15 connect the processing circuits 24 to the vertical signal lines 21 and 22 through the switches 25. Each switch 25 has a movable contact connected to the corresponding one of the processing circuits 24. The switch 25 further has fixed contacts respectively connected to the vertical signal lines 21 and 22 corresponding to this processing circuit 24. The switch 25 is configured to connect selected one of the vertical signal lines 21 and 22 to this processing circuit 24, for each pixel column. The switch 25 switches selection of the vertical signal lines 21 and 22, in response to a control signal from the control circuit 13.

The connection parts 15 may have any configuration that can switch between the first connection state shown in FIG. 4 and the second connection state shown in FIG. 5. In the first connection state, the connection parts 15 stop driving of the switches 25 shown in FIG. 5, and connect the vertical signal lines 21 and 22 to the processing circuits 24, as shown in FIG. 4. In the second connection state, the connection parts 15 cancel the connection of the vertical signal lines 21 and 22 to the processing circuits 24 shown in FIG. 4, and drive the respective switches 25 shown in FIG. 5.

The connection parts 15 may include a switching mechanism (not shown) other than the switches 25 shown in FIG. 5. The switching mechanism is a mechanism configured to switch between a state that connects wiring lines to each other and a state that cancels the connection. The connection parts 15 drive the switching mechanism to switch between the first connection state and the second connection state.

In the second imaging mode, the control circuit 13 supplies a pulse signal for sequentially selecting pixel rows one by one to the row scanning circuit 14. The row scanning circuit 14 supplies a drive signal to the pixels of sequentially selected one of the pixel rows, in response to the pulse signal from the control circuit 13. The row scanning circuit 14 performs selective scanning that sequentially shifts the selection target formed of one pixel row in the column direction.

The row scanning circuit 14 supplies a drive signal, in the order of the pixel rows L1, L2 - - - . In response to a drive signal supplied to the pixel row L1, the pixel cell 23-11 outputs a pixel signal from the Gr pixel in the pixel row L1 to the vertical signal line 21-1.

When the row scanning circuit 14 selects a first pixel row, the switches 25 of the connection parts 15 connect the vertical signal lines 21 to the processing circuits 24. The pixel signal transmitted through the vertical signal line 21-1 is input into the processing circuit 24-1. Similarly to the pixel cell 23-11, the pixel cells 23-12, 23-13, and 23-14 respectively output pixel signals from the pixels in the pixel row L1 to the vertical signal lines 21-2, 21-3, and 21-4. The pixel signals transmitted through the vertical signal lines 21-2, 21-3, and 21-4 are respectively input into the processing circuits 24-2, 24-3, and 24-4.

The processing circuits 24-1 to 24-4 respectively process the pixel signals input from the connection parts 15. The processing circuits 24-1 to 24-4 sequentially output the processed pixel signals, in response to selective scanning by the column scanning circuit 17 in a horizontal read period T1.

In the horizontal read period T1, the image signals read from the image sensor 10 are respectively composed of signal components from the Gr pixels “1” and the R pixels “1” positioned in the pixel row L1. For example, a signal component Gr1 processed by the processing circuit 24-1 corresponds to a pixel signal from one Gr pixel “1” positioned in the pixel row L1.

In a horizontal read period T2, the image signals read from the image sensor 10 are respectively composed of signal components from the Gr pixels “2” and the R pixels “2” positioned in the pixel row L2. For example, a signal component B2 processed by the processing circuit 24-1 corresponds to a pixel signal from one B pixel “2” positioned in the pixel row L2.

In the second imaging mode, the image signals read from the image sensor 10 are formed such that the arrangement of signal components from respective pixels matches the pixel arrangement in the pixel array 12. Thus, in the second imaging mode, the arrangement conversion part 20 does not perform arrangement conversion of signal components. In the horizontal read periods T1 and T2, each of the image signals read from the image sensor 10 is output from the solid-state imaging device 5, without being held by the arrangement conversion part 20.

Also for the pixel rows L3 and L4, the solid-state imaging device 5 performs the same operation as performed for the pixel rows L1 and L2. After finishing read of pixel signals from the pixels in the pixel rows L1 to L4 serving as first pixel rows, the connection parts 15 connect the vertical signal lines 22 to the processing circuits 24. When the row scanning circuit 14 selects a second pixel row, the switches 25 of the connection parts 15 connect the vertical signal lines 22 to the processing circuits 24.

The pixel signals from the pixels in the pixel rows L5 to L8 serving as second pixel rows are input into the processing circuits 24 through the vertical signal lines 22. Also for the remaining pixel rows following the pixel rows L1 to L8, the solid-state imaging device 5 repeats the same operation as performed for the pixel rows L1 to L8.

From information obtained by the pixel array 12, the solid-state imaging device 5 generates an image signal without performing either of the charge-adding and the voltage-averaging of signal components by the binning process. In second imaging mode, the solid-state imaging device 5 can obtain a high definition image.

The solid-state imaging device 5 can set the frame rate in the first imaging mode to be theoretically four times the frame rate in the second imaging mode. The imaging in the first imaging mode is suitable for imaging of a high-speed motion picture and imaging of a slow motion picture.

The solid-state imaging device 5 may use the connection parts 15 in the second connection state to perform a binning process that simultaneously reads signals from two pixels in each pixel cell 23. The row scanning circuit 14 simultaneously selects two pixel rows. In this case, the solid-state imaging device 5 can perform imaging at a frame rate set to be two times the frame rate in the second imaging mode described above.

When performing the binning in the row direction, the solid-state imaging device 5 may increase the drive frequency of the processing circuits 24. The solid-state imaging device 5 may increase the drive frequency of the processing circuits 24 in the first imaging mode to be larger than the drive frequency of the processing circuits 24 in the second imaging mode. Consequently, the solid-state imaging device 5 can improve the frame rate in the first imaging mode.

The solid-state imaging device 5 may be provided with pixel cells of a 2V1H pixel sharing structure, in place of the pixel cells 23 of the 4V1H pixel sharing structure. Each pixel cell of the 2V1H pixel sharing structure is composed of two pixels arrayed in the column direction. Two first pixel cells connected to a first signal line and two second pixel cells connected to a second signal line are alternately disposed in the column direction. The voltages of pixel signals simultaneously output from the two first pixel cells to the first signal line are averaged between them. The voltages of pixel signals simultaneously output from the two second pixel cells to the second signal line are averaged between them. Also in this case, the solid-state imaging device 5 can read pixel signals at a high speed in the first imaging mode, as in the case of the 4V1H.

According to the first embodiment, in the first imaging mode, the solid-state imaging device 5 connects a first signal line and a second signal line for each pixel column to processing circuits different from each other. Pixel signals from first pixels and pixel signals from second pixels in the same pixel column are simultaneously processed by processing circuits 24 different from each other. The solid-state imaging device 5 utilizes the processing circuits provided correspondingly to the pixel columns, such that processing circuits other than the processing circuits used for processing pixel signals from first pixel cells are used to process pixel signals from second pixel cells.

The solid-state imaging device 5 simultaneously performs read of pixel signals from a first pixel cell through the first signal line and read of pixel signals from a second pixel cell through the second signal line. The solid-state imaging device 5 simultaneously reads pixel signals from a first pixel cell and a second pixel cell in the same pixel column, and thereby increases the speed of reading pixel signals in the row direction. The solid-state imaging device 5 can perform read of image signals at a high speed. The solid-state imaging device 5 can realize high-speed read of pixel signals, without increasing the number of processing circuits relative to the number of pixel columns. The solid-state imaging device 5 allows a binning process to be performed in the row direction and the column direction. By performing a binning process, the solid-state imaging device 5 can realize it to prevent the image quality from deteriorating and prevent the sensitivity from lowering.

### Second Embodiment

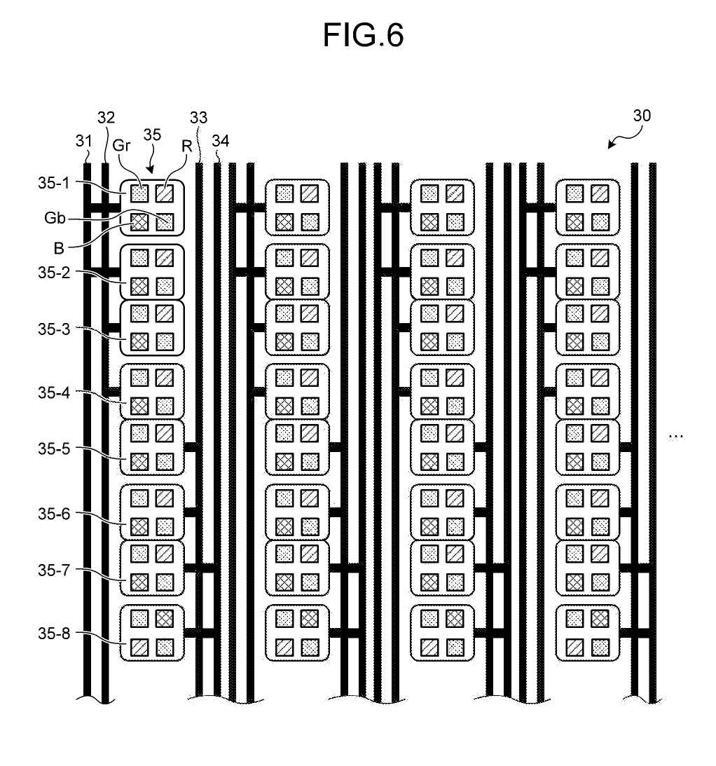

FIG. 6 is a view showing a schematic configuration of a pixel array provided in a solid-state imaging device according to a second embodiment. The constituent elements corresponding to those of the first embodiment described above are denoted by the same reference symbols, and their repetitive description will be suitably omitted. The solid-state imaging device 5 according to the second embodiment is provided with a pixel array 30 in place of the pixel array 12 of the solid-state imaging device 5 according to the first embodiment.

The pixel array 30 is composed of pixel cells 35 arrayed in a matrix format. Each pixel cell 35 includes four pixels. The four pixels form a matrix with two pixels in the row direction and two pixels in the column direction. The four pixels share a MOS transistor serving as a component of the pixels. This pixel sharing structure according to the second embodiment will be referred to as “2V2H pixel sharing structure” in the explanation hereinafter. The four pixels in each pixel cell 35 are similar to those in the unit pixel block of the Bayer array.

In the pixel array 30, four vertical signal lines 31 to 34 are provided for each column of pixel cells 35 arrayed in the column direction. One processing circuit 24 and first and second signal lines are provided per one pixel column of the pixel array 30. The pixel array 30 outputs pixel signals from each pixel cell 35 to any one of the vertical signal lines 31 to 34.

The vertical signal lines 31 and 32 serve as first signal lines. The vertical signal lines 33 and 34 serve as second signal lines. Pixel cells 35-1 and 35-2 serving as first pixel cells are connected to the vertical signal line 31 common to them. Pixel cells 35-3 and 35-4 serving as first pixel cells are connected to the vertical signal line 32 common to them.

Pixel cells 35-5 and 35-6 serving as second pixel cells are connected to the vertical signal line 33 common to them. pixel cells 35-7 and 35-8 serving as second pixel cells are connected to the vertical signal line 34 common to them. In each column of pixel cells 35, a group of four first pixel cells and a group of four second pixel cells are alternately disposed in the column direction.

In the second embodiment, the solid-state imaging device 5 is supposed to be able to switch imaging modes between a first imaging mode and a second imaging mode. In the first imaging mode, the solid-state imaging device 5 performs a binning process similar to that performed in the first imaging mode according to the first embodiment. In the second imaging mode, the solid-state imaging device 5 stops the binning process, as in the second imaging mode according to the first embodiment.

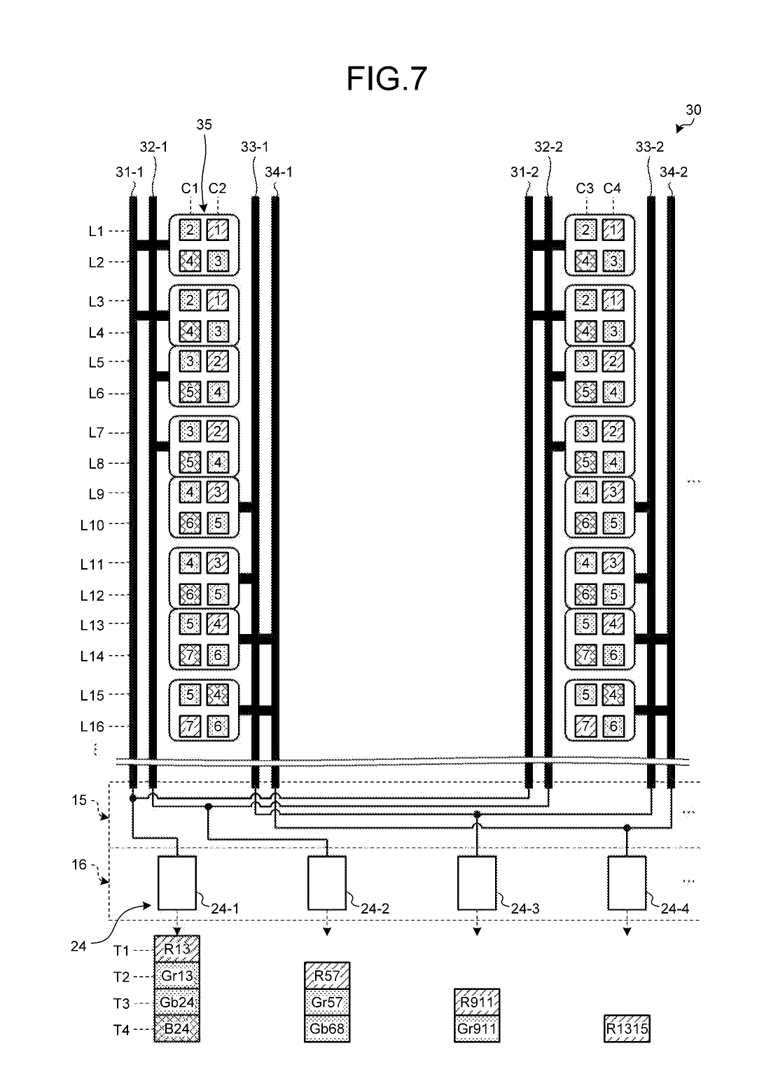

FIG. 7 is a view for explaining an operation of the solid-state imaging device in the first imaging mode according to the second embodiment. The solid-state imaging device 5 performs 2×2 binning that simultaneously reads pixel signals in relation to two pixels in the row direction and two pixels in the column direction.

The connection parts 15 connect the vertical signal lines 31-1, 31-2, 32-1, 32-2, 33-1, 33-2, 34-1, and 34-2 to the processing circuits 24. In the first imaging mode, the connection parts 15 are set in a first connection state that includes short-circuiting between two vertical signal lines. The first connection state includes short-circuiting between two vertical signal lines (31-1 and 31-2, 32-1 and 32-2, - - - ) serving as first signal lines, and short-circuiting between two vertical signal lines (33-1 and 33-2, 34-1 and 34-2, - - - ) serving as second signal lines.

When a mode selection signal for setting the imaging mode to the first imaging mode is input into the control circuit 13, the control circuit 13 outputs a control signal corresponding to the first imaging mode to the connection parts 15. In response to the control signal from the control circuit 13, the connection parts 15 come into the first connection state shown in FIG. 7.

For each column of pixel cells, the connection parts 15 connect the first signal lines and the second signal lines to processing circuits 24 different from each other. Also for the columns of pixel cells 35 other than the pixel columns C1 to C4, the connection parts 15 form the same connection state as formed for the columns of pixel cells 35 corresponding to the pixel columns C1 to C4. As long as the first imaging mode is set as the imaging mode, the connection parts 15 keep the connection state between the vertical signal lines 31 to 34 and the processing circuits 24.

In the second embodiment, the solid-state imaging device 5 can read signals from the two pixels arrayed in the row direction in each pixel cell 35 at timings different from each other. For example, in the solid-state imaging device 5, two pixel drive lines are provided for each pixel row. The solid-state imaging device 5 uses the two pixel drive lines to read signals from the two pixels arrayed in the row direction at different timings.

The connection parts 15 connect the vertical signal line 31-1, which is provided for the pixel columns C1 and C2 serving as first pixel columns, and the vertical signal line 31-2, which is provided for the pixel columns C3 and C4 serving as second pixel columns, to a processing circuit 24-1 serving as a first processing circuit. The connection parts 15 connect the vertical signal line 32-1, which is provided for the pixel columns C1 and C2, and the vertical signal line 32-2, which is provided for the pixel columns C3 and C4, to a processing circuit 24-2 serving as a first processing circuit.

At the first timing in a frame period, the row scanning circuit 14 simultaneously selects two pixel rows L1 and L3 serving as first pixel rows. The row scanning circuit 14 supplies a drive signal to the R pixels in the pixel rows L1 and L3. At the two pixel cells 35 corresponding to the pixel columns C1 and C2, the signals of the R pixels are simultaneously read. The voltages of pixel signals simultaneously output from the two pixel cells 35 to the vertical signal line 31-1 are averaged between them. Similarly, the voltages of pixel signals simultaneously output from the pixel cells 35 corresponding to the pixel columns C3 and C4 to the vertical signal line 31-2 are averaged between them.

The pixel signals transmitted through the vertical signal line 31-1 and the pixel signals transmitted through the vertical signal line 31-2 are input into the processing circuit 24-1. The voltages of pixel signals input into the processing circuit 24-1 are averaged between them. Consequently, the processing circuit 24-1 obtains a pixel signal derived from the four R pixels included in the four pixels cell 35. The processing circuit 24-1 processes pixel signals input from the connection parts 15.

In a horizontal read period T1, the image sensor 10 outputs an image signal containing a signal component R13 processed by the processing circuit 24-1. The signal component R13 corresponds to pixel signals detected by the four R pixels “1” positioned in the pixel rows L1 and L3.

Then, the row scanning circuit 14 simultaneously selects four pixel rows L1, L3, L5, and L7 serving as first pixel rows. The row scanning circuit 14 supplies a drive signal to the Gr pixels in the pixel rows L1 and L3 and the R pixels in the pixel rows L5 and L7. In a horizontal read period T2, the image sensor 10 outputs an image signal containing signal components Gr13 and R57.

The signal component Gr13 is a signal component processed by the processing circuit 24-1, and it corresponds to pixel signals detected by the four Gr pixels “2” positioned in the pixel rows L1 and L3. The signal component R57 is a signal component processed by the processing circuit 24-2, and it corresponds to pixel signals detected by the four R pixels “2” positioned in the pixel rows L5 and L7.

Then, the row scanning circuit 14 simultaneously selects six pixel rows L2, L4, L5, L7, L9, and L11. The pixel rows L2, L4, L5, and L7 serve as first pixel rows. The pixel rows L9 and L11 serve as second pixel rows.

The connection parts 15 connect the vertical signal line 33-1, which is provided for the pixel columns C1 and C2 serving as first pixel columns, and the vertical signal line 33-2, which is provided for the pixel columns C3 and C4 serving as second pixel columns, to a processing circuit 24-3 serving as a second processing circuit. The connection parts 15 connect the vertical signal line 34-1, which is provided for the pixel columns C1 and C2, and the vertical signal line 34-2, which is provided for the pixel columns C3 and C4, to a processing circuit 24-4 serving as a second processing circuit.

The row scanning circuit 14 supplies a drive signal to the Gb pixels in the pixel rows L2 and L4, the Gr pixels in the pixel rows L5 and L7, and the R pixels in the 2) pixel rows L9 and L11. In a horizontal read period T3, the image sensor 10 outputs an image signal containing signal components Gb24, Gr57, and R911.

The signal component Gb24 is a signal component processed by the processing circuit 24-1, and it corresponds to pixel signals detected by the four Gb pixels “3” positioned in the pixel rows L2 and L4. The signal component Gr57 is a signal component processed by the processing circuit 24-2, and it corresponds to pixel signals detected by the four Gr pixels “3” positioned in the pixel rows L5 and L7. The signal component R911 is a signal component processed by the processing circuit 24-3, and it corresponds to pixel signals detected by the four R pixels “3” positioned in the pixel rows L9 and L11.

Then, the row scanning circuit 14 simultaneously selects eight pixel rows L2, L4, L5, L7, L9, L11, L13, and L15. The pixel rows L2, L4, L5, and L7 serve as first pixel rows. The pixel rows L9, L11, L13, and L15 serve as second pixel rows. The row scanning circuit 14 supplies a drive signal to the B pixels in the pixel rows L2 and L4, the Gb pixels in the pixel rows L5 and L7, the Gr pixels in the pixel rows L9 and L11, and the R pixels in the pixel rows L13 and L15. In a horizontal read period T4, the image sensor 10 outputs an image signal containing signal components B24, Gb68, Gr911, and R1315.

The signal component B24 is a signal component processed by the processing circuit 24-1, and it corresponds to pixel signals detected by the four B pixels “4” positioned in the pixel rows L2 and L4. The signal component Gb68 is a signal component processed by the processing circuit 24-2, and it corresponds to pixel signals detected by the four Gb pixels “4” positioned in the pixel rows L6 and L8.

The signal component Gr911 is a signal component processed by the processing circuit 24-3, and it corresponds to pixel signals detected by the four Gr pixels “4” positioned in the pixel rows L9 and L11. The signal component R1315 is a signal component processed by the processing circuit 24-4, and it corresponds to pixel signals detected by the four R pixels “4” positioned in the pixel rows L13 and L15.

The row scanning circuit 14 repeats read of pixel signals from eight pixel columns, in accordance with the same rule as used in the horizontal read periods T1 to T4. The row scanning circuit 14 simultaneously selects four first pixel rows and four second pixel rows. The arrangement conversion part 20 converts the arrangement of signal components of an image signal, so that the arrangement of signal components from respective pixels matches the pixel arrangement order in the pixel array 30.

Also for the remaining pixel rows following the pixel rows L1 to L16, the solid-state imaging device 5 performs the same operation as performed for the pixel rows L1 to L16. The solid-state imaging device 5 performs the 2×2 binning, and thereby reduces the data amount of an image signal in half, in each of the column direction and the row direction. By reducing the data amount of each image signal read from the image sensor 10, the solid-state imaging device 5 can perform high-speed imaging.

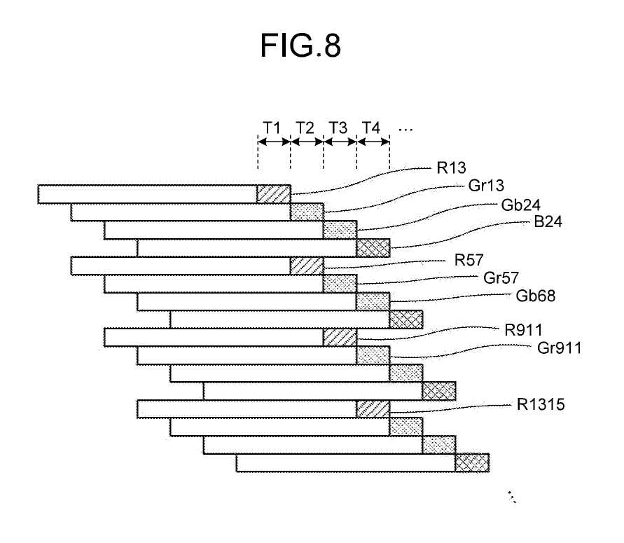

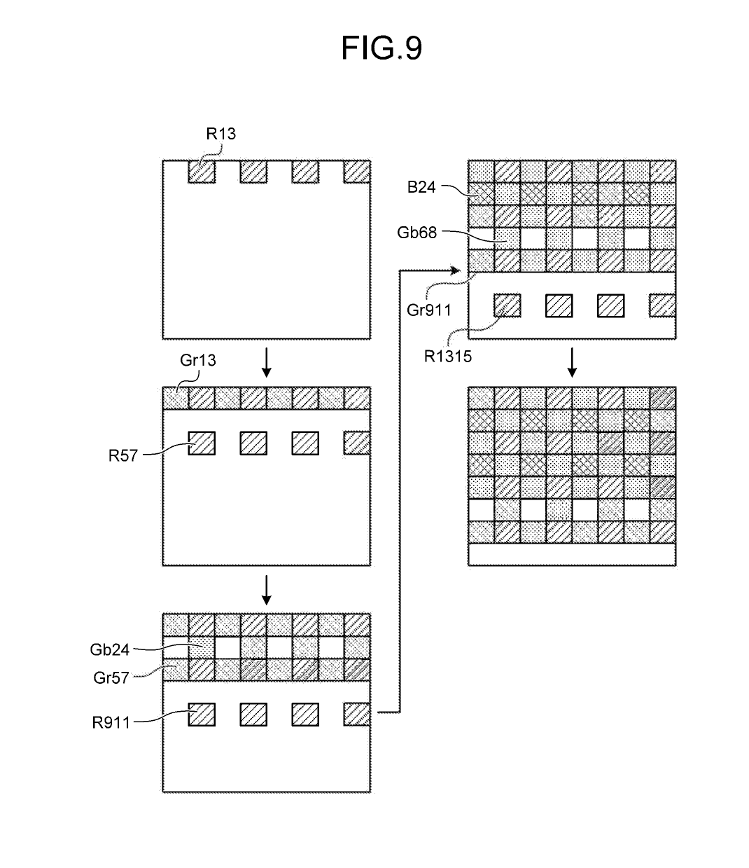

FIG. 8 is a view for explaining timings at which pixel signals are read from the image sensor in the first imaging mode according to the second embodiment. FIG. 8 uses the horizontal direction as a time axis, and shows a light exposure time and a period of reading an image signal, for each of the pixel rows from which pixel signals are simultaneously read. In FIG. 8, each portion without hatching denotes the light exposure time, and each portion with hatching denotes a horizontal read period that is the period of reading an image signal. FIG. 9 is a view for explaining a course of pixel signals being read from the image sensor in respective horizontal read periods shown in FIG. 8.

The signal components R13, Gr13, Gb24, and B24 correspond to pixel signals generated from pixels in a pixel block defined by the pixel rows L1 to L4 and the pixel columns C1 to C4 in the pixel array 30. The control circuit 13 controls the row scanning circuit 14 to read the respective color signal components from the 4×4 pixel block in the order of R, Gr, Gb, and B.

The image sensor 10 reads the Gr and Gb signal components continuously in this order in each 4×4 pixel block. As compared with the R pixel and the B pixel, the G pixel is a pixel having larger influence on the image brightness. As compared with the R and B signal components, the Gr and Gb signal components contain a larger amount of brightness information of the object. By reducing the gap in read timing between the Gr and Gb signal components, the solid-state imaging device 5 can prevent the image quality from deteriorating. The solid-state imaging device 5 can effectively reduce noises, when photographing a moving body traveling at a high speed.

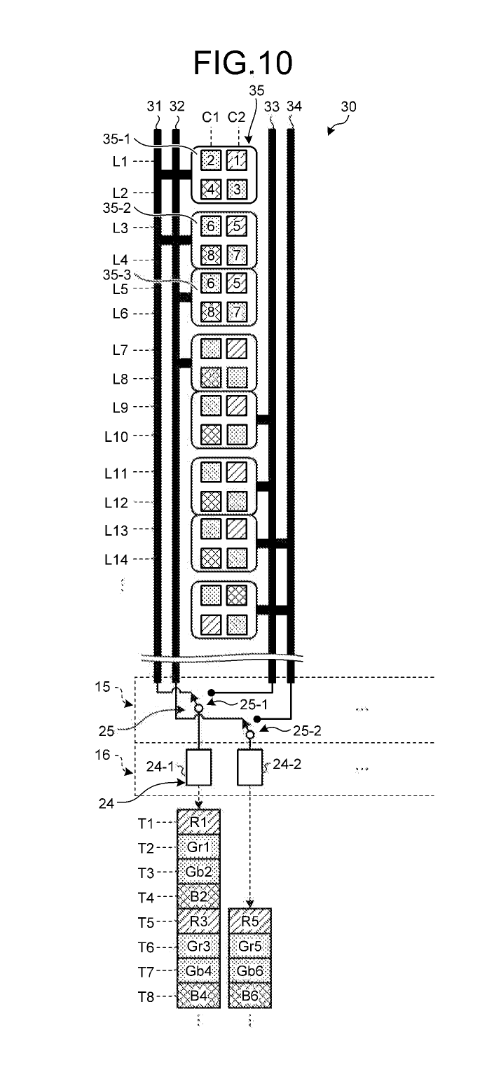

FIG. 10 is a view for explaining an operation of the solid-state imaging device in the second imaging mode according to the second embodiment. In the second imaging mode, the solid-state imaging device 5 does not perform the voltage-averaging of signal components from a plurality of pixels, but sequentially reads signal components from the respective pixels of the pixel array 30. In the second imaging mode, the connection parts 15 come into a connection state that includes switches 25 respectively provided for the processing circuits 24. FIG. 10 shows the connection parts 15 in one of the situations in the second connection state. The connection parts 15 may include a switching mechanism (not shown), as in the first embodiment.

When a mode selection signal for setting the imaging mode to the second imaging mode is input into the control circuit 13, the control circuit 13 outputs a control signal corresponding to the second imaging mode to the connection parts 15. In response to the control signal from the control circuit 13, the connection parts 15 come into a connection state including the switches 25.

As shown in FIG. 10, the connection parts 15 connect the processing circuits 24 to the vertical signal lines 31 to 34 through the switches 25. The connection parts 15 include two switches 25-1 and 25-2 arranged to correspond to a column of pixel cells 35 arrayed in the column direction. The switches 25-1 and 25-2 have movable contacts respectively connected to two of the processing circuits 24. The switches 25-1 and 25-2 further have fixed contacts respectively connected to the vertical signal lines 31 to 34 corresponding to these two processing circuits 24.

The switch 25-1 is configured to connect selected one of the vertical signal lines 31 and 33 to the processing circuit 24-1. The switch 25-1 switches selection of the vertical signal lines 31 and 33, in response to a control signal from the control circuit 13. The switch 25-2 is configured to connect selected one of the vertical signal lines 32 and 34 to the processing circuit 24-2. The switch 25-2 switches selection of the vertical signal lines 32 and 34, in response to a control signal from the control circuit 13.

When the row scanning circuit 14 supplies a drive signal to the pixel rows L1 to L6, the switch 25-1 selects the vertical signal line 31. The switch 25-2 selects the vertical signal line 32.

At first in a frame period, the row scanning circuit 14 sequentially supplies a drive signal to the respective pixels of the pixel cell 35-1 positioned in the pixel rows L1 and L2. The pixel signals from the respective pixels of the pixel cell 35-1 are sequentially input into the processing circuit 24-1. In horizontal read periods T1 to T4, the image sensor 10 outputs an image signal containing signal component R1, Gr1, Gb2, and B2 from the processing circuit 24-1.

Then, the row selection circuit 14 simultaneously selects two pixel rows L3 and L5. The row scanning circuit 14 supplies a drive signal to the R pixel in the pixel row L3 and the R pixel in the pixel row L5. In a horizontal read period T5, the image sensor 10 outputs an image signal containing signal components R3 and R5. The row selection circuit 14 supplies a drive signal to the pixels of the pixel cells 35-2 and 35-3 positioned in the pixel rows L3 to L6, in the order of R, Gr, Gb, and B. In horizontal read periods T5 to T8, the image sensor 10 outputs an image signal containing signal components R3, Gr3, Gb4, and B4 from the processing circuit 24-1 and signal components R5, Gr5, Gb6, and B6 from the processing circuit 24-2.

Also for the remaining pixel rows following the pixel rows L3 to L6, the row selection circuit 14 simultaneously selects two pixel rows. When the row scanning circuit 14 supplies a drive signal to the pixel rows L7 to L10, the switch 25-1 selects the vertical signal line 33. The switch 25-2 selects the vertical signal line 32. When the row scanning circuit 14 supplies a drive signal to the pixel rows L11 to L14, the switch 25-1 selects the vertical signal line 33. The switch 25-2 selects the vertical signal line 34.

When the row scanning circuit 14 supplies a drive signal to the pixel rows L15 to L18, the switch 25-1 selects the vertical signal line 31. The switch 25-2 selects the vertical signal line 34. The row scanning circuit 14 repeats read of pixel signals from two pixel rows, in accordance with the same rule as used in the horizontal read periods T5 to T8. The arrangement conversion part 20 converts the arrangement of signal components of an image signal, so that the arrangement of signal components from respective pixels matches the pixel arrangement in the row direction.

From information obtained by the pixel array 30, the solid-state imaging device 5 generates an image signal without performing the adding of pixel signals by the binning process. The solid-state imaging device 5 can obtain a high definition image.

The solid-state imaging device 5 can set the frame rate in the first imaging mode to be theoretically four times the frame rate in the second imaging mode. The imaging in the first imaging mode is suitable for imaging of a high-speed motion picture and imaging of a slow motion picture.

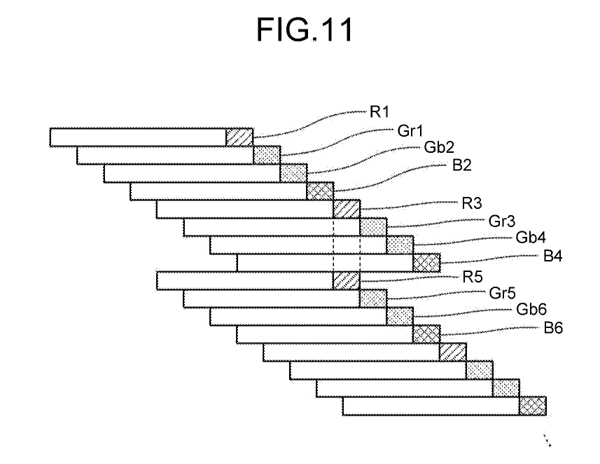

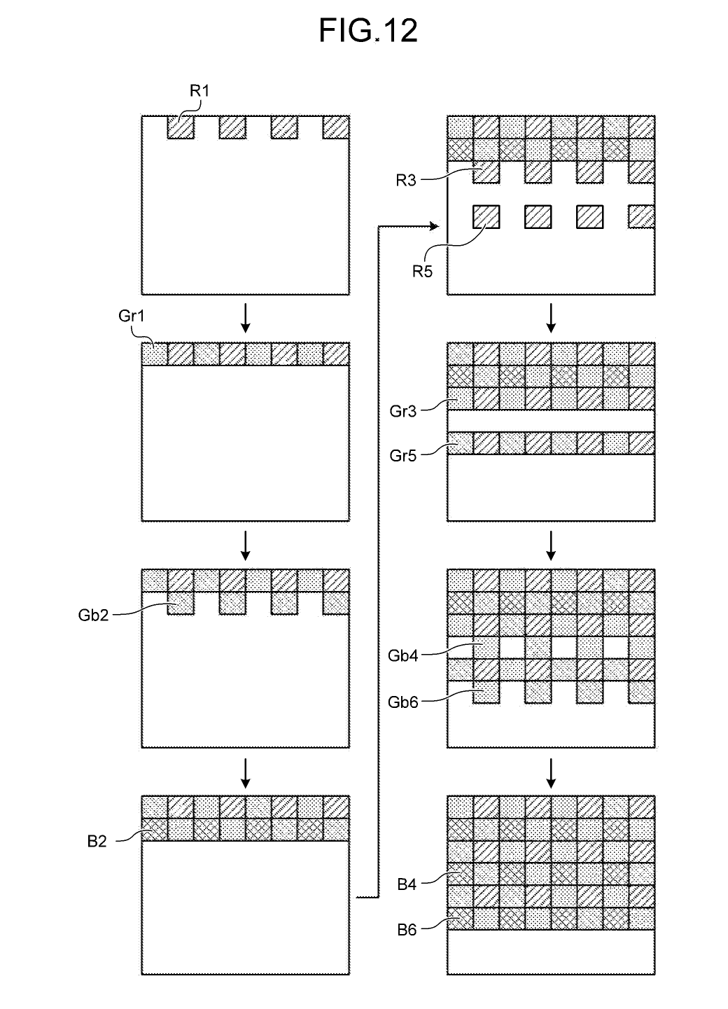

FIG. 11 is a view for explaining timings at which pixel signals are read from the image sensor in the second imaging mode according to the second embodiment. FIG. 12 is a view for explaining a course of pixel signals being read from the image sensor in respective horizontal read periods shown in FIG. 11. The control circuit 13 controls the row scanning circuit 14 to read the respective color signal components from each pixel cell 35 in the order of R, Gr, Gb, and B.

The image sensor 10 reads the Gr and Gb signal components continuously in this order in each pixel cell 35. By reducing the gap in read timing between the Gr and Gb signal components, the solid-state imaging device 5 can prevent the image quality from deteriorating, as in the first imaging mode.

In the second embodiment, the row scanning circuit 14 may be designed to select pixel rows one by one in a third imaging mode other than the first and second imaging modes. In the third imaging mode, the solid-state imaging device 5 sequentially reads pixel signals in the order of the pixel rows L1, L2, - - - .

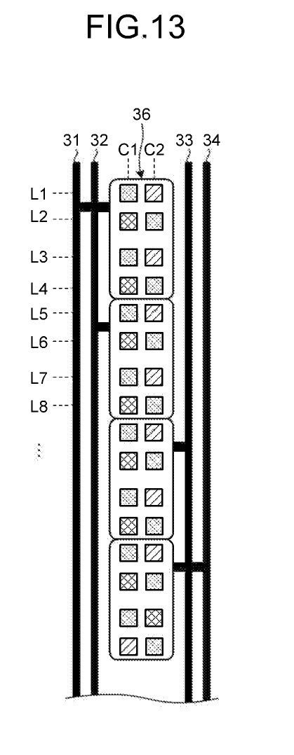

FIG. 13 is a view for explaining a modification according to the second embodiment. According to this modification, a solid-state imaging device 5 is provided with pixel cells 36 of a 4V2H pixel supply structure. Each pixel cell 36 is composed of eight pixels. The eight pixels form a matrix with two pixels in the row direction and four pixels in the column direction.

The pixel cells 36 are disposed to correspond to respective sets of four pixel rows L1 to L4, L5 to L8, - - - , in the column direction. Also in this modification provided with the pixel cells 36, the solid-state imaging device 5 performs read of image signals by use of first and second imaging modes, as in the configuration provided with the pixel cells 35 described above. Also according to this modification, the solid-state imaging device 5 can perform imaging of a high-speed motion picture, and can further prevent the sensitivity from lowering and prevent the image quality from deteriorating.

According to the second embodiment, the solid-state imaging device 5 simultaneously performs read of pixel signals from first pixel cells through the first signal lines and read of pixel signals from second pixel cells through the second signal lines. The solid-state imaging device 5 can perform imaging of a high-speed motion picture, and can further realize it to prevent the sensitivity from lowering and prevent the image quality from deteriorating.

### Third Embodiment

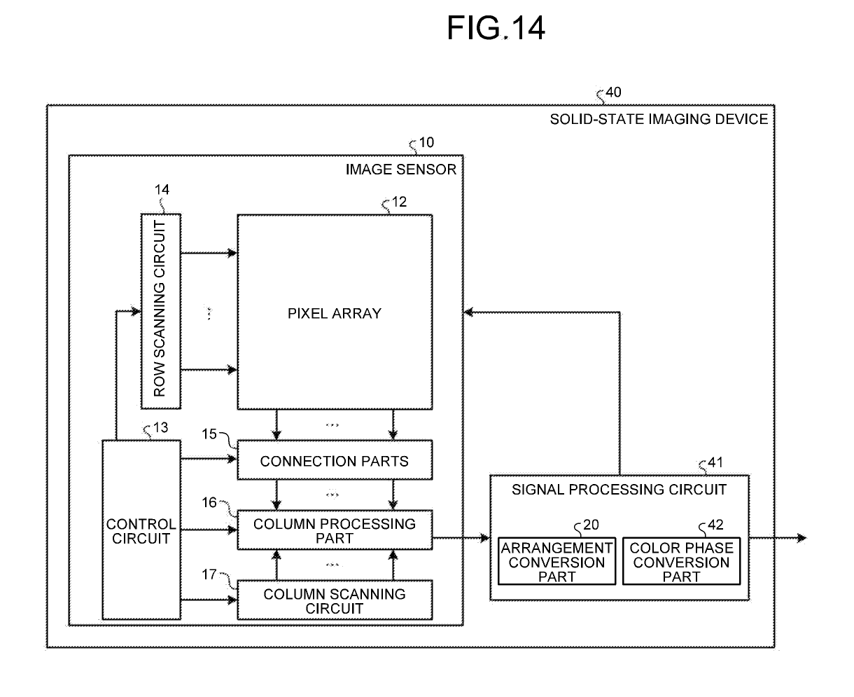

FIG. 14 is a block diagram showing a configuration of a solid-state imaging device according to a third embodiment. The constituent elements corresponding to those of the first embodiment described above are denoted by the same reference symbols, and their repetitive description will be suitably omitted.

The solid-state imaging device 40 according to the third embodiment is configured to perform read of image signals by use of first and second imaging modes the same as those used in the solid-state imaging device 5 according to the first embodiment, and to further perform read of image signals by use of a third imaging mode.

The solid-state imaging device 40 includes an image sensor 10 and a signal processing circuit 41. The signal processing circuit 41 includes an arrangement conversion part 20 and a color phase conversion part 42. The color phase conversion part 42 performs color phase conversion for each frame to an image signal from the image sensor 10. By performing the color phase conversion, the color phase conversion part 42 obtains an image signal in which components derived from pixels for detecting light of colors different from each other are in a state arranged in a predetermined arrangement order.

The camera system 1 may be designed such that the ISP 6 of the back-end processor 3 can perform at least any one of the signal processes mentioned as being performed by the signal processing circuit 41 in this embodiment. The function of the color phase conversion part 42 may be provided in the ISP 6 in place of the signal processing circuit 41.

In the first imaging mode, the solid-state imaging device 40 performs a binning process that simultaneously reads pixel signals from a plurality of pixels, as described in the first embodiment. Further, in the second imaging mode, the solid-state imaging device 40 sequentially reads pixel signals from the pixels in each row and each column of the pixel array 12, as described in the first embodiment. Further, in the third imaging mode, the solid-state imaging device 40 performs a thinning process that thins out the number of pixels to read pixel signals therefrom.

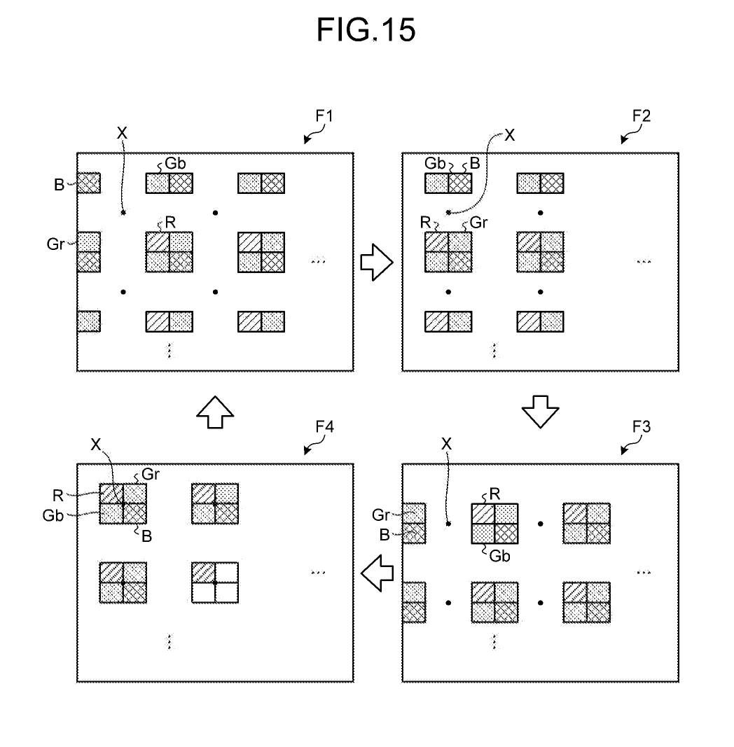

FIG. 15 is a view for explaining the thinning process in the third imaging mode according to the third embodiment. For each frame, the solid-state imaging device 40 reads pixel signals from pixels, the number of which is a quarter of the total number of effective pixels in the pixel array 12. For four continuous frames, the solid-state imaging device 40 reads pixel signals respectively from different pixels. The solid-state imaging device 40 sequentially changes the target pixels to read pixel signals therefrom at a cycle of four frame periods.

In the first frame period F1 of continuous four frame periods F1 to F4, the image sensor 10 first reads pixel signals from B pixels. Four pixels serving as a unit of the Bayer array are positioned at the four corners of each pixel block defined by four rows and four columns with a position X at the center. In the second frame period F2 next to the first frame period F1, the image sensor 10 first reads pixel signals from Gb pixels. Four pixels serving as a unit of the Bayer array are positioned at the four corners of each pixel block defined by four rows and two columns with the position X at the center.

In the third frame period F3 next to the second frame period F2, the image sensor 10 first reads pixel signals from R pixels. Four pixels serving as a unit of the Bayer array are positioned at the four corners of each pixel block defined by two rows and four columns with the position X at the center. In the fourth frame period F4 next to the third frame period F3, the image sensor 10 first reads pixel signals from Gr pixels. Four pixels serving as a unit of the Bayer array form each pixel block defined by two rows and two columns with the position X at the center.

By performing the thinning process shown in FIG. 15, the gravity center of four pixels serving as a unit of the Bayer array conforms to the center of a pixel block including these four pixels, in each of the frame periods.

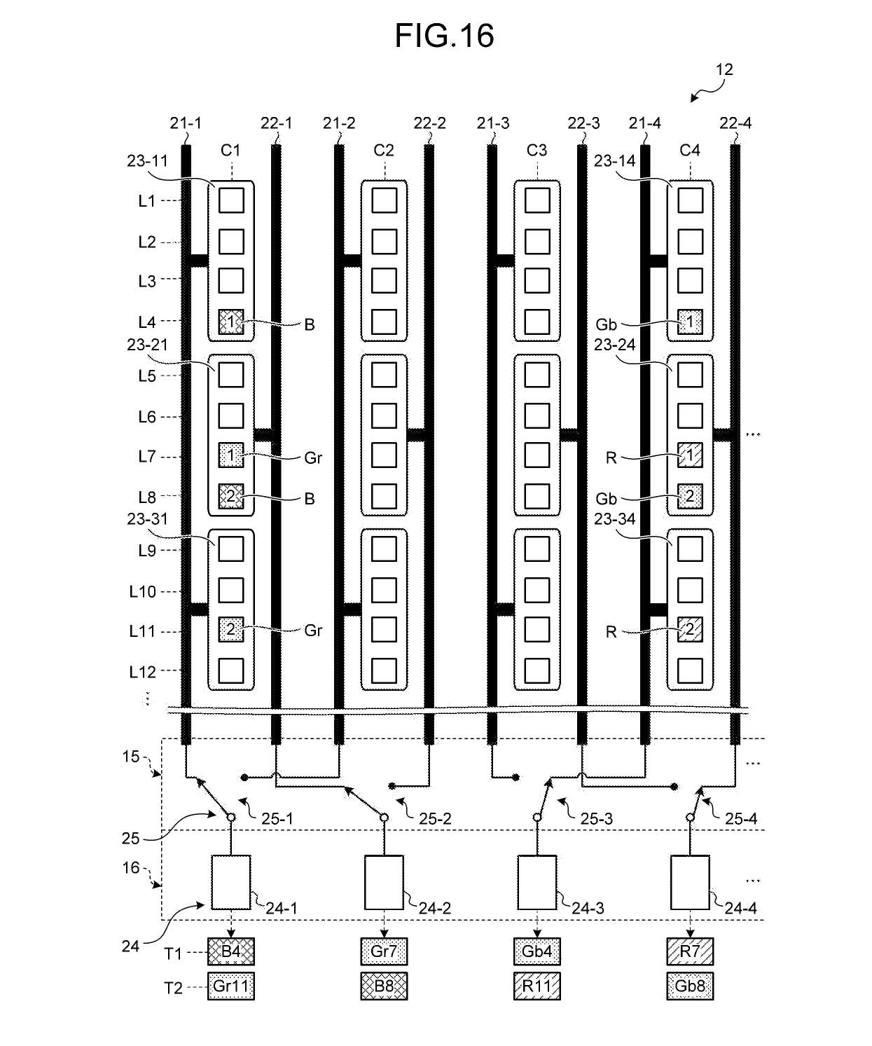

FIG. 16 is a view for explaining an operation of the solid-state imaging device in the first frame period shown in FIG. 15. In the third imaging mode, the connection parts 15 come into a connection state that includes switches 25 respectively provided for the processing circuits 24.

When a mode selection signal for setting the imaging mode to the third imaging mode is input into the control circuit 13, the control circuit 13 outputs a control signal corresponding to the third imaging mode to the connection parts 15. In response to the control signal from the control circuit 13, the connection parts 15 come into a third connection state including the switches 25.

As shown in FIG. 16, the connection parts 15 connect the processing circuits 24 to the vertical signal lines 21 and 22 through the switches 25. In the connection parts 15, the switches 25 are respectively provided for the pixel columns. Each switch 25 has a movable contact connected to the corresponding one of the processing circuits 24. The switch 25 further has fixed contacts respectively connected to two vertical signal lines 21 and 21 serving as first signal lines or two vertical signal lines 22 and 22 serving as second signal lines.

For two pixel columns C1 and C2, a switch 25-1 is configured to connect selected one of vertical signal lines 21-1 and 21-2 to a processing circuit 24-1 serving as a first processing circuit, In response to a control signal from the control circuit 13, the switch 25-1 switches selection of the vertical signal lines 21-1 and 21-2. For two pixel columns C1 and C2, a switch 25-2 is configured to connect selected one of vertical signal lines 22-1 and 22-2 to a processing circuit 24-2 serving as a second processing circuit. In response to a control signal from the control circuit 13, the switch 25-2 switches selection of the vertical signal lines 22-1 and 22-2.

For two pixel columns C3 and C4, a switch 25-3 is configured to connect selected one of vertical signal lines 21-3 and 21-4 to a processing circuit 24-3 serving as a first processing circuit. In response to a control signal from the control circuit 13, the switch 25-3 switches selection of the vertical signal lines 21-3 and 21-4. For two pixel columns C3 and C4, a switch 25-4 is configured to connect selected one of vertical signal lines 22-3 and 22-4 to a processing circuit 24-4 serving as a second processing circuit. In response to a control signal from the control circuit 13, the switch 25-4 switches selection of the vertical signal lines 22-3 and 22-4.

At first in the first frame period F1, the row scanning circuit 14 simultaneously supplies a drive signal to two pixel rows L4 and L7. The pixel row L4 is a first pixel row. The pixel row L7 is a second pixel row. The row scanning circuit 14 does not supply a drive signal to any of pixel rows L1, L3, L5, and L6 to be treated as thinning targets.

The row scanning circuit 14 performs row scanning to the pixels in the pixel rows L4 and L7, to read pixel signals respectively from the pixels corresponding to the pixel column C1 and the pixels corresponding to the pixel column C4. During the first frame period F1, the row scanning circuit 14 does not read pixel signals from the pixels in the pixel columns C2 and C3. Also for the remaining pixel columns following the pixel columns C1 and C4, the row scanning circuit 14 performs the row scanning to read pixel signals, at intervals of two pixel columns.

The row scanning circuit 14 selects the pixel column C1 of the two pixel columns C1 and C2, which serves as a first pixel column. The switch 25-1 connects the vertical signal line 21-1 of the vertical signal lines 21-1 and 21-2, which is provided for the pixel column C1, to the processing circuit 24-1 serving as a first processing circuit. The switch 25-2 connects the vertical signal line 22-1 of the vertical signal lines 22-1 and 22-2, which is provided for the pixel column C1, to the processing circuit 24-2 serving as a second processing circuit.

The row scanning circuit 14 selects the pixel column C4 of the two pixel columns C3 and C4, which serves as a second pixel column. The switch 25-3 connects the vertical signal line 21-4 of the vertical signal lines 21-3 and 21-4, which is provided for the pixel column C4, to the processing circuit 25-3 serving as a first processing circuit. The switch 25-4 connects the vertical signal line 22-4 of the vertical signal lines 22-3 and 22-4, which is provided for the pixel column C4, to the processing circuit 25-4 serving as a second processing circuit.

As described above, in the first frame period F1, the switches 25-1 to 25-4 respectively select the vertical signal lines 21-1, 22-1, 21-4, and 22-4.

The pixel cell 23-11 in the pixel column C1 outputs a pixel signal read from the B pixel in the pixel row L4 to the vertical signal line 21-1. The pixel cell 23-14 in the pixel column C4 outputs a pixel signal read from the Gb pixel in the pixel row L4 to the vertical signal line 21-4. The pixel cell 23-21 in the pixel column C1 outputs a pixel signal read from the Gr pixel in the pixel row L7 to the vertical signal line 22-1. The pixel cell 23-24 in the pixel column C4 outputs a pixel signal read from the R pixel in the pixel row L7 to the vertical signal line 22-4.

The pixel signals transmitted through the vertical signal lines 21-1, 22-1, 21-4, and 22-4 are respectively input into the processing circuits 24-1, 24-2, 24-3, and 24-4. The processing circuits 24-1 to 24-4 sequentially output the processed pixel signals, in response to selective scanning by the column scanning circuit 17 in a horizontal read period T1. Signal components B4, Gr7, Gb4, and R7 read in the horizontal read period T1 correspond to pixel signals respectively detected by the B, Gr, Gb, and R pixels denoted with “1” in FIG. 16.

Then, the row scanning circuit 14 simultaneously supplies a drive signal to two pixel rows L8 and L11. The pixel row L8 is a second pixel row. The pixel row L11 is a first pixel row. The row scanning circuit 14 does not supply a drive signal to either of pixel rows L9 and L10 to be treated as thinning targets.

In a horizontal read period T2, the image sensor 10 outputs an image signal containing signal components Gr11, B8, R11, and Gb8. These signal components correspond to pixel signals respectively detected by the Gr, B, R, and Gb pixels denoted with “2” in the pixel cells 23-21, 23-24, 23-31, and 23-34 shown in FIG. 16.

The arrangement conversion part 20 converts the arrangement of signal components of an image signal, so that the arrangement of signal components from respective pixels matches the pixel arrangement order in the pixel array 12. The arrangement conversion part 20 rearranges the signal components B4, Gr7, Gb4, and R7 read in the horizontal read period T1 into the order of B4, Gb4, Gr7, and R7, in accordance with the order rule. The arrangement conversion part 20 rearranges the signal components Gr11, B8, R11, and Gb8 read in the horizontal read period T2 into the order of B8, Gb8, Gr11, and R11, in accordance with the order rule.

The solid-state imaging device 40 outputs an image signal with signal components corresponding to four pixels serving as a unit of the Bayer array, in accordance with a standard arrangement order, such as the order of Gr, R, B, and Gb. The color phase conversion part 42 performs color phase conversion to obtain an image signal in which signal components derived from respective color pixels are in a state arranged in this standard arrangement order.

The color phase conversion part 42 performs an interpolating process by filtering, as the color phase conversion. For example, in order to obtain a G signal component at a region where a B signal component has been obtained, the color phase conversion part 42 performs an interpolating process based on G signal components obtained at neighboring regions of this region.

The four signal components B4, Gb4, Gr7, and R7 read in the horizontal read period T1 form a unit of the Bayer array. The color phase conversion part 42 generates a Gr signal component (Gr4′) for a region where the signal component B4 has been obtained. The color phase conversion part 42 generates an R signal component (R4′) for a region where the signal component Gb4 has been obtained. The color phase conversion part 42 generates a B signal component (B7′) for a region where the signal component Gr7 has been obtained. The color phase conversion part 42 generates a Gb signal component (Gb7′) for a region where the signal component R7 has been obtained.

The four signal components B8, Gb8, Gr11, and R11 read in the horizontal read period T2 form a unit of the Bayer array. The color phase conversion part 42 generates a Gr signal component (Gr8′), an R signal component (R8′), a B signal component (B11′), and a Gb signal component (Gb11′) respectively for regions where the signal components B8, Gb8, Gr11, and R11 have been obtained.

Also for the remaining pixel columns following the pixel columns C1 and C4, the color phase conversion part 42 performs the same color phase conversion as performed for the pixel columns C1 and C4. By performing the color phase conversion by use of the color phase conversion part 42, the solid-state imaging device 40 can obtain an image signal in which signal components derived from respective color pixels are in a state arranged in the standard arrangement order. Consequently, the camera system 1 can perform a demosaic process to signal components set in a constant arrangement order, by processing means, such as the ISP 6, subsequent to the solid-state imaging device 40.

Also for the remaining pixel rows following the pixel rows L4, L7, L8, and L11, the solid-state imaging device 40 performs the same operation as performed for the pixel rows L4, L7, L8, and L11. The row scanning circuit 14 simultaneously selects one first pixel row and one second pixel row.

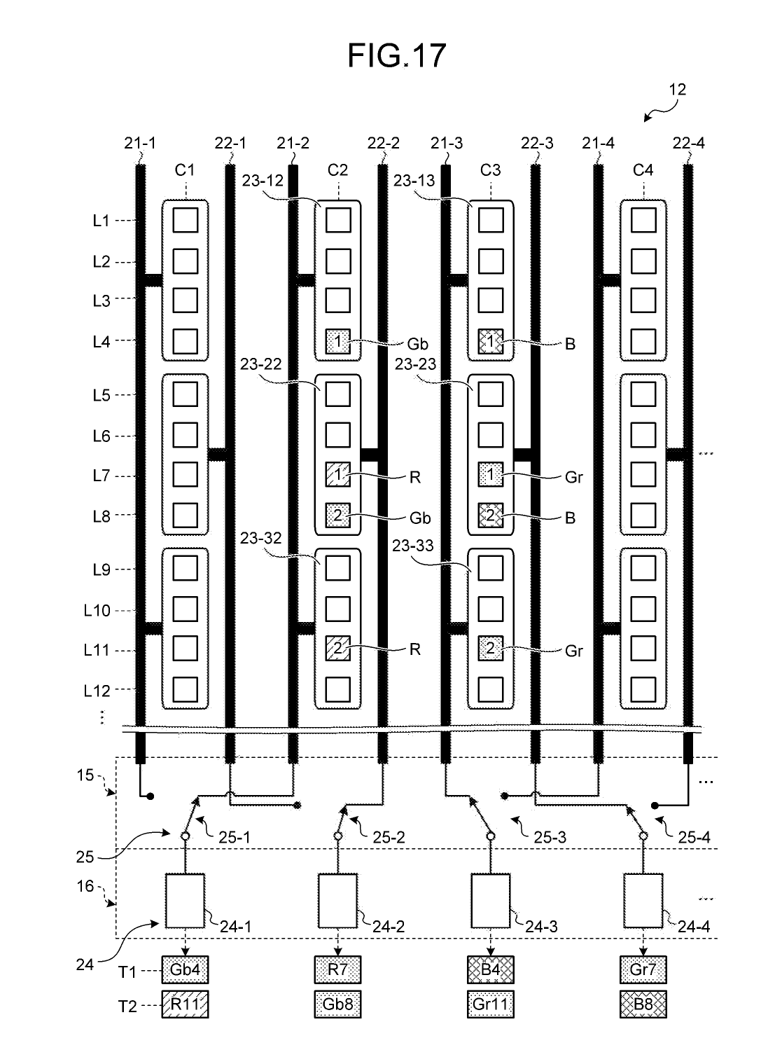

FIG. 17 is a view for explaining an operation of the solid-state imaging device in the second frame period shown in FIG. 15. At first in the second frame period F2, the row scanning circuit 14 simultaneously supplies a drive signal to two pixel rows L4 and L7. The row scanning circuit 14 does not supply a drive signal to any of pixel rows L1, L3, L5, and L6 to be treated as thinning targets.

The row scanning circuit 14 performs row scanning to the pixels in the pixel rows L4 and L7, to read pixel signals respectively from the pixels corresponding to the pixel column C2 and the pixels corresponding to the pixel column C3. Also for the remaining pixel columns following the pixel columns C2 and C3, the row scanning circuit 14 performs the row scanning to read pixel signals, at intervals of two pixel columns.

The row scanning circuit 14 selects the pixel column C2 of the two pixel columns C1 and C2, which serves as a second pixel column. The switch 25-1 connects the vertical signal line 21-2 of the vertical signal lines 21-1 and 21-2, which is provided for the pixel column C2, to the processing circuit 24-1 serving as a first processing circuit. The switch 25-2 connects the vertical signal line 22-2 of the vertical signal lines 22-1 and 22-2, which is provided for the pixel column C2, to the processing circuit 24-2 serving as a second processing circuit.

The row scanning circuit 14 selects the pixel column C3 of the two pixel columns C3 and C4, which serves as a first pixel column. The switch 25-3 connects the vertical signal line 21-3 of the vertical signal lines 21-3 and 21-4, which is provided for the pixel column C3, to the processing circuit 25-3 serving as a first processing circuit. The switch 25-4 connects the vertical signal line 22-3 of the vertical signal lines 22-3 and 22-4, which is provided for the pixel column C3, to the processing circuit 25-4 serving as a second processing circuit.

As described above, in the second frame period F2, the switches 25-1 to 25-4 respectively select the vertical signal lines 21-1, 22-1, 21-4, and 22-4.

In a horizontal read period T1, the image sensor 10 outputs an image signal containing signal components Gb4, R7, B4, and Gr7. These signal components correspond to pixel signals respectively detected by the Gb, R, B, and Gr pixels denoted with “1” in the pixel cells 23-12, 23-13, 23-22, and 23-23 shown in FIG. 17. The arrangement conversion part 20 holds an image signal read from the image sensor 10 in the horizontal read period T1.

Then, the row scanning circuit 14 simultaneously supplies a drive signal to two pixel rows L8 and L11. The row scanning circuit 14 does not supply a drive signal to either of pixel rows L9 and L10 to be treated as thinning targets. In a horizontal read period T2, the image sensor 10 outputs an image signal containing signal component R11, Gb8, Gr11, and B8. These signal components correspond to pixel signals respectively detected by the R, Gb, Gr, and B pixels denoted with “2” in the pixel cells 23-12, 23-13, 23-22, and 23-23 shown in FIG. 17.

The arrangement conversion part 20 rearranges the signal components Gb4, R7, B4, and Gr7 read in the horizontal read period T1 into the order of Gb4, B4, R7, and Gr7, in accordance with the order rule. The arrangement conversion part 20 rearranges the signal components R11, Gb8, Gr11, and B8 read in the horizontal read period T2 into the order of Gb8, B8, R11, and Gr11, in accordance with the order rule.

The color phase conversion part 42 generates a Gr signal component (Gr4′), an R signal component (R4′), a B signal component (B7′), and a Gb signal component (Gb7′) respectively for regions where the signal components Gb4, B4, R7, and Gr7 have been obtained. The color phase conversion part 42 generates a Gr signal component (Gr8′), an R signal component (R8′), a B signal component (B11′), and a Gb signal component (Gb11′) respectively for regions where the signal components Gb8, B8, R11, and Gr11 have been obtained.

Also for the remaining pixel columns following the pixel columns C2 and C3, the color phase conversion part 42 performs the same color phase conversion as performed for the pixel columns C2 and C3. Also for the remaining pixel rows following the pixel rows L4, L7, L8, and L11, the solid-state imaging device 40 performs the same operation as performed for the pixel rows L4, L7, L8, and L11. The row scanning circuit 14 simultaneously selects one first pixel row and one second pixel row.

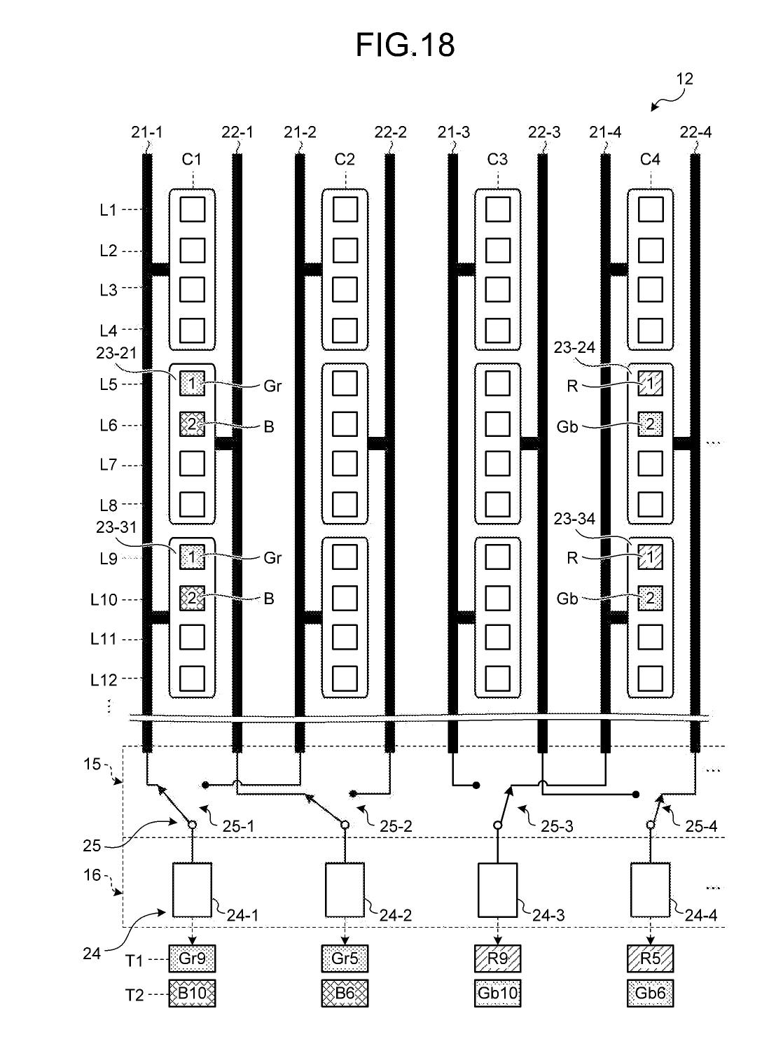

FIG. 18 is a view for explaining an operation of the solid-state imaging device in the third frame period shown in FIG. 15. In the third frame period F3, the switches 25-1 to 25-4 respectively select the vertical signal lines 21-1, 22-1, 21-4, and 22-4, as in the first frame period F1.

At first in the third frame period F3, the row scanning circuit 14 simultaneously supplies a drive signal to two pixel rows L5 and L9. The row scanning circuit 14 does not supply a drive signal to either of pixel rows L7 and L8 to be treated as thinning targets.

The row scanning circuit 14 performs row scanning to the pixels in the pixel rows L5 and L9, to read pixel signals respectively from the pixels corresponding to the pixel column C1 and the pixels corresponding to the pixel column C4. Also for the remaining pixel columns following the pixel columns C1 and C4, the row scanning circuit 14 performs the row scanning to read pixel signals, at intervals of two pixel columns.

In a horizontal read period T1, the image sensor 10 outputs an image signal containing signal components Gr9, Gr5, R9, and R5. These signal components correspond to pixel signals respectively detected by the Gr, Gr, R, and R pixels denoted with “1” in the pixel cells 23-21, 23-24, 23-31, and 23-34 shown in FIG. 18. The arrangement conversion part 20 holds an image signal read from the image sensor 10 in the horizontal read period T1.

Then, the row scanning circuit 14 simultaneously supplies a drive signal to two pixel rows L6 and L10. In a horizontal read period T2, the image sensor 10 outputs an image signal containing signal components B10, B6, Gb10, and Gb6. These signal components correspond to pixel signals respectively detected by the B, B, Gb, and Gb pixels denoted with “2” in FIG. 18.

The arrangement conversion part 20 holds an image signal read from the image sensor 10 in the horizontal read period T2. The arrangement conversion part 20 rearranges the above-mentioned eight signal components read in the horizontal read periods T1 and T2 into the order of Gr5, R5, B6, Gb6, Gr9, R9, B10, and Gb10.

The four signal components Gr5, R5, B6, and Gb6 contained in the image signal from the arrangement conversion part 20 form a unit of the Bayer array. These four signal components are in a state arranged in the standard arrangement order described above. The four signal components Gr9, R9, B10, and Gb10 are also in a state arranged in the standard arrangement order. In the third frame period F3, the signal components of the Bayer array are in a state arranged in the standard arrangement order, and thus the color phase conversion part 42 does not perform the color phase conversion.

Also for the remaining pixel rows following the pixel rows L5, L6, L9, and L10, the solid-state imaging device 40 performs the same operation as performed for the pixel rows L5, L6, L9, and L10. The row scanning circuit 14 simultaneously selects one first pixel row and one second pixel row.

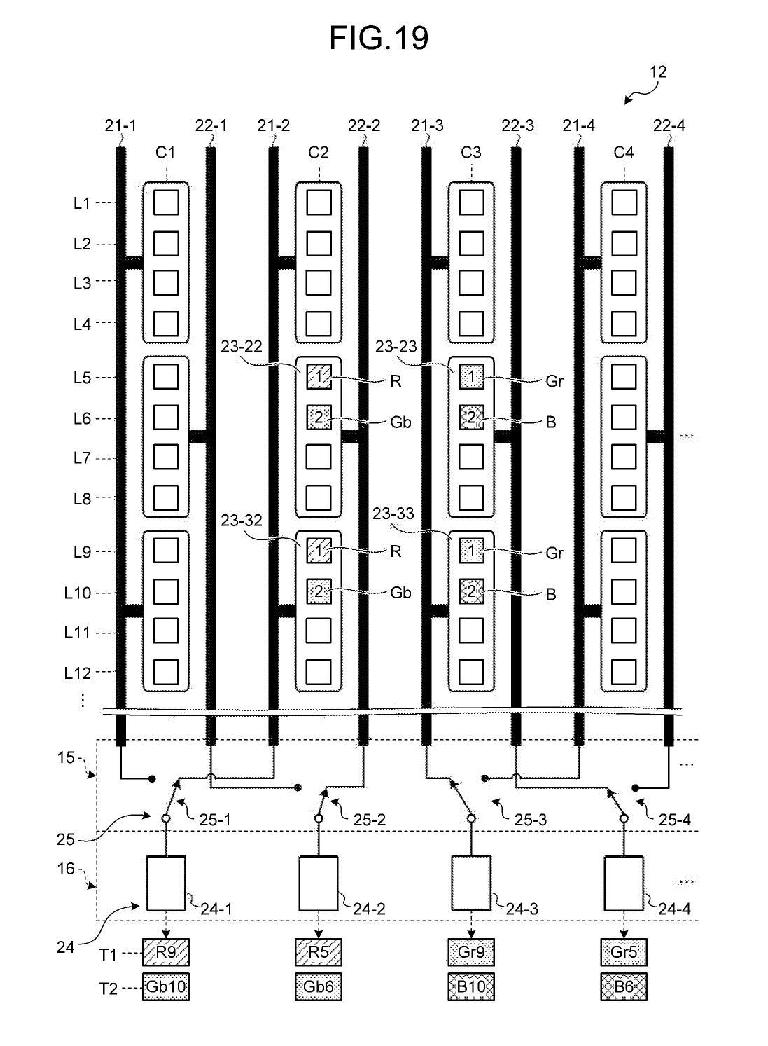

FIG. 19 is a view for explaining an operation of the solid-state imaging device in the fourth frame period shown in FIG. 15. In the fourth frame period F4, the switches 25-1 to 25-4 respectively select the vertical signal lines 21-2, 22-2, 21-3, and 22-3, as in the second frame period F2.

At first in the fourth frame period F4, the row scanning circuit 14 simultaneously supplies a drive signal to two pixel rows L5 and L9. The row scanning circuit 14 does not supply a drive signal to either of pixel rows L7 and L8 to be treated as thinning targets.

The row scanning circuit 14 performs row scanning to the pixels in the pixel rows L5 and L9, to read pixel signals respectively from the pixels corresponding to the pixel column C2 and the pixels corresponding to the pixel column C3. Also for the remaining pixel columns following the pixel columns C2 and C3, the row scanning circuit 14 performs the row scanning to read pixel signals, at intervals of two pixel columns.

In a horizontal read period T1, the image sensor 10 outputs an image signal containing signal components R9, R5, Gr9, and Gr5. These signal components correspond to pixel signals respectively detected by the R, R, Gr, and Gr pixels denoted with “1” in the pixel cells 23-22, 23-23, 23-32, and 23-33 shown in FIG. 19. The arrangement conversion part 20 holds an image signal read from the image sensor 10 in the horizontal read period T1.

Then, the row scanning circuit 14 simultaneously supplies a drive signal to two pixel rows L6 and L10. In a horizontal read period T2, the image sensor 10 outputs an image signal containing signal components Gb10, Gb6, B10, and B6. These signal components correspond to pixel signals respectively detected by the Gb, Gb, B, and B pixels denoted with “2” in the pixel cells 23-22, 23-23, 23-32, and 23-33 shown in FIG. 19.

The arrangement conversion part 20 holds an image signal read from the image sensor 10 in the horizontal read period T2. The arrangement conversion part 20 rearranges the above-mentioned eight signal components read in the horizontal read periods T1 and T2 into the order of R5, Gr5, Gb6, B6, R9, Gr9, Gb10, and B10.

The color phase conversion part 42 generates a Gr signal component (Gr5′), an R signal component (R5′), a B signal component (B6′), and a Gb signal component (Gb6′) respectively for regions where the signal components R5, Gr5, Gb6, and B6 have been obtained. The color phase conversion part 42 generates a Gr signal component (Gr9′), an R signal component (R9′), a B signal component (B10′), and a Gb signal component (Gb10′) respectively for regions where the signal components R9, Gr9, Gb10, and B10 have been obtained.

Also for the remaining pixel rows following the pixel rows L5, L6, L9, and L10, the solid-state imaging device 40 performs the same operation as performed for the pixel rows L5, L6, L9, and L10. The row scanning circuit 14 simultaneously selects one first pixel row and one second pixel row.

The solid-state imaging device 40 has a configuration in which a first signal line and a second signal line are provided for each pixel column, as in the solid-state imaging device 5 according to the first embodiment. The solid-state imaging device 40 can realize a thinning process that changes pixels to read pixel signals therefrom, at every frame, in the same configuration as that of the first embodiment.

The solid-state imaging device 40 performs thinning to skip two of four pixel columns in the row direction and two of four pixel rows in the column direction, when reading an image signal. The solid-state imaging device 40 performs the thinning process, and thereby reduces the data amount of an image signal in half, in each of the column direction and the row direction.

By reducing the data amount of each image signal read from the image sensor 10, the solid-state imaging device 40 can perform high-speed imaging. The solid-state imaging device 40 can prevent the sense of resolution from lowering, as compared with a case where data amount reduction equivalent to this embodiment is performed by use of thinning only on the pixel rows. The solid-state 4) imaging device 40 can prevent stepwise noises, which are so called jaggies, from being generated at the contour of the object image, when imaging a motion picture. The solid-state imaging device 40 can prevent the image quality from deteriorating.

The solid-state imaging device 40 may be designed such that the light exposure time used for a case that performs the thinning process is set longer than the light exposure time used for a case that reads pixel signals from the pixels in each row and each column of the pixel array 12. The control circuit 13 controls the reset and transfer timings such that the charge accumulate time between the charge reset and the charge transfer for each pixel is longer in the third imaging mode than in the second imaging mode. In accordance with control by the control circuit 13, the light exposure time for each frame in the third imaging mode is set longer than the light exposure time in the second imaging mode.

Consequently, the solid-state imaging device 40 can obtain a bright image even in a low luminance environment. If the light exposure time in the third imaging mode is set not to exceed four times the light exposure time in the second imaging mode, the solid-state imaging device 40 can set the frame rate of the third imaging mode to be equal to or larger than the frame rate of the second imaging mode.

The solid-state imaging device 40 may be designed such that the continuous four frame periods include frame periods having light exposure times different from each other. The solid-state imaging device 40 can realize high dynamic range synthesis by use of the frame of a longer light exposure time and the frame of a shorter light exposure time. Consequently, the solid-state imaging device 40 can obtain a clear image over a wide luminance range. If the light exposure time of at least one of a plurality of frame periods in the third imaging mode is set longer than the light exposure time in the second imaging mode, the solid-state imaging device 40 can obtain a bright and clear image.

The camera system 1 may be designed such that the respective signal components of an image signal can be recognized, as to which color pixel each signal component corresponds to, by a demosaic processing means (not shown) provided at the post stage. By performing a process in accordance with the arrangement of signal components of the respective colors, the demosaic processing means can perform an accurate demosaic process, regardless of the signal component order. In this case, the solid-state imaging device 40 may omit the color phase conversion part 42.

The solid-state imaging device 40 may be designed such that the connection parts 15 are set in the third connection state, and a binning process is performed to simultaneously read signals from two pixels in each pixel cell 23. The row scanning circuit 14 simultaneously selects four pixel rows. In this case, the solid-state imaging device 40 can read an image signal containing information from pixels in a number twice as large as that of the third imaging mode described above.

The solid-state imaging device 40 may be designed such that a thinning process similar to that of the third embodiment is performed in a configuration including the pixel array 30 according to the second embodiment. Also in this case, the solid-state imaging device 40 can perform imaging of a high-speed motion picture.

According to the third embodiment, the solid-state imaging device 40 simultaneously performs read of a pixel signal from a first pixel cell through the first signal line and read of a pixel signal from a second pixel cell through the second signal line. The solid-state imaging device 40 can perform high-speed imaging by use of the simultaneous read of pixel signals and the thinning process. The solid-state imaging device 40 can perform imaging of a high-speed motion picture, and can further prevent the sensitivity from lowering and prevent the image quality from deteriorating.

### Fourth Embodiment

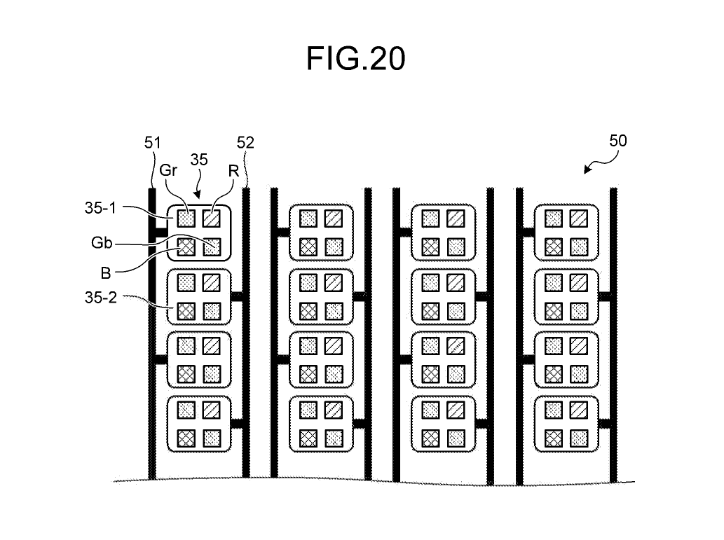

FIG. 20 is a view showing a schematic configuration of a pixel array provided in a solid-state imaging device according to a fourth embodiment. The constituent elements corresponding to those of the first and second embodiments described above are denoted by the same reference symbols, and their repetitive description will be suitably omitted. The solid-state imaging device 40 according to the fourth embodiment is provided with a pixel array 50 in place of the pixel array 12 of the solid-state imaging device 40 according to the third embodiment.

The pixel array 50 is composed of pixel cells 35 having a 2V2H pixel sharing structure, as in the pixel array 30 according to the second embodiment. In the pixel array 50, two vertical signal lines 51 and 52 are provided for each column of pixel cells 35 arrayed in the column direction. The pixel array 50 outputs pixel signals from each pixel cell 35 to either one of the vertical signal lines 51 and 52.

A pixel cell 35-1 serving as a first pixel cell is connected to the vertical signal line 51 serving as a first signal line. A pixel cell 35-2 serving as a second pixel cell is connected to the vertical signal line 52 serving as a second signal line. In each column of pixel cells, the first pixel cell and the second pixel cell are alternately disposed in the column direction.

In the fourth embodiment, the solid-state imaging device 40 is supposed to be able to switch imaging modes between a first imaging mode and a second imaging mode. In the first imaging mode, the solid-state imaging device 40 performs a thinning process similar to that performed in the third imaging mode according to the third embodiment. In the second imaging mode, the solid-state imaging device 40 stops the thinning process. In the second imaging mode, the solid-state imaging device 40 sequentially reads pixel signals from the pixels in each row and each column of the pixel array 50.

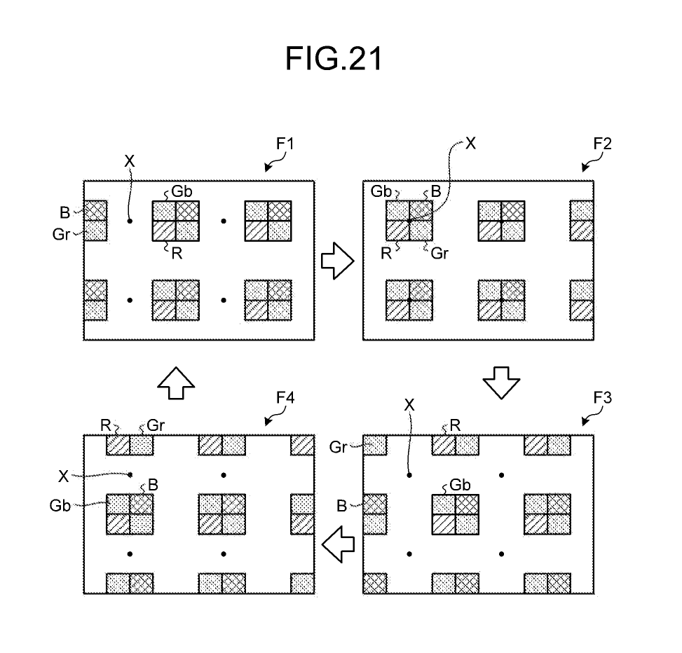

FIG. 21 is a view for explaining a thinning process in the first imaging mode according to the fourth embodiment. For each frame, the solid-state imaging device 40 reads pixel signals from pixels, the number of which is a quarter of the total number of effective pixels in the pixel array 12. For four continuous frames, the solid-state imaging device 40 reads pixel signals respectively from different pixels. The solid-state imaging device 40 sequentially changes the target pixels to read pixel signals therefrom at a cycle of four frame periods.

In the first frame period F1 of continuous four frame periods F1 to F4, the image sensor 10 first reads pixel signals from B pixels. Four pixels serving as a unit of the Bayer array are positioned at the four corners of each pixel block defined by two rows and four columns with a position X at the center. In the second frame period F2 next to the first frame period F1, the image sensor 10 first reads pixel signals from Gb pixels. Four pixels serving as a unit of the Bayer array form each pixel block defined by two rows and two columns.

In the third frame period F3 next to the second frame period F2, the image sensor 10 first reads pixel signals from Gr pixels. Four pixels serving as a unit of the Bayer array are positioned at the four corners of each pixel block defined by four rows and four columns with the position X at the center. In the fourth frame period F4 next to the third frame period F3, the image sensor 10 first reads pixel signals from R pixels. Four pixels serving as a unit of the Bayer array are positioned at the four corners of each pixel block defined by four rows and two columns with the position X at the center.

By performing the thinning process shown in FIG. 21, the gravity center of four pixels serving as a unit of the Bayer array conforms to the center of a pixel block including these four pixels, in each of the frame periods.

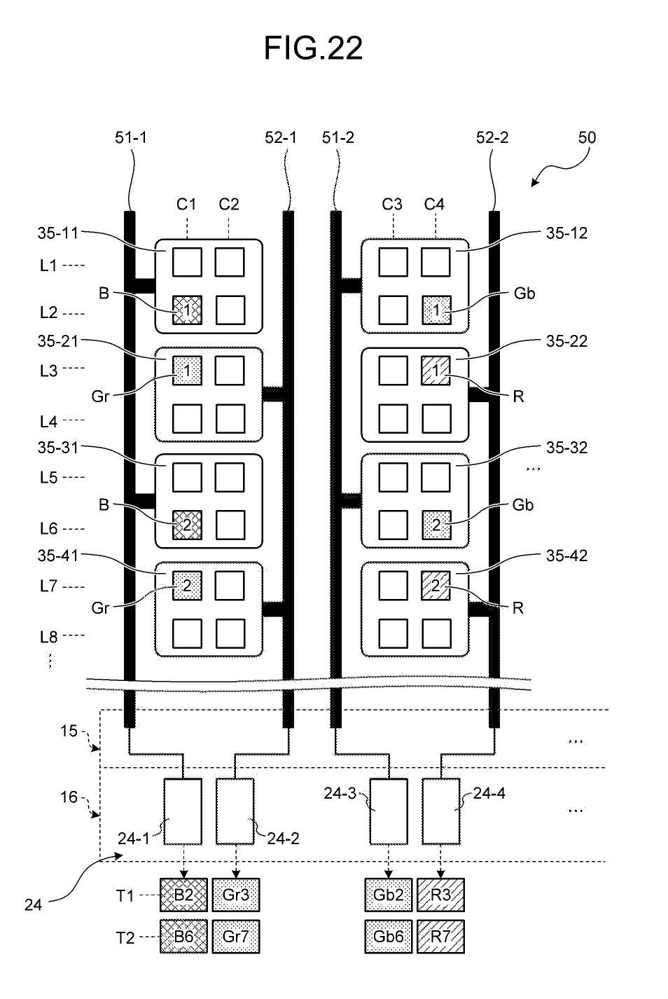

FIG. 22 is a view for explaining an operation of the solid-state imaging device in the first frame period shown in FIG. 21. In the fourth embodiment, two processing circuits 24 respectively serving as first and second processing circuits and vertical signal lines 51 and 52 respectively serving as first and second signal lines are provided for each column of pixel cells 35.

Two processing circuits 24-1 and 24-2 are provided for a column of pixel cells 35-11, 35-21, - - - corresponding to pixel columns C1 and C2. The connection parts 15 connect the processing circuit 24-1 serving as a first processing circuit to a vertical signal line 51-1, and connects the processing circuit 24-2 serving as a second processing circuit to a vertical signal line 52-1.

Two processing circuits 24-3 and 24-4 are provided for a column of pixel cells 35-12, 35-22, - - - corresponding to pixel columns C3 and C4. The connection parts 15 connect the processing circuit 24-3 serving as a first processing circuit to a vertical signal line 51-2, and connects the processing circuit 24-4 serving as a second processing circuit to a vertical signal line 52-2. In the fourth embodiment, the connection parts 15 keep this connection state, regardless of the imaging mode.

At first in the first frame period F1, the row scanning circuit 14 simultaneously supplies a drive signal to two pixel rows L2 and L3. The pixel row L2 is a first pixel row. The pixel row L3 is a second pixel row. The row scanning circuit 14 does not supply a drive signal to either of pixel rows L1 and L4 to be treated as thinning targets.

The row scanning circuit 14 performs row scanning to the pixels in the pixel rows L2 and L3, to read pixel signals respectively from the pixels corresponding to the pixel column C1 and the pixels corresponding to the pixel column C4. During the first frame period F1, the row scanning circuit 14 does not read pixel signals from the pixels in the pixel columns C2 and C3. Also for the remaining pixel columns following the pixel columns C1 and C4, the row scanning circuit 14 performs the row scanning to read pixel signals, at intervals of two pixel columns.

The pixel cell 35-11 in the pixel columns C1 and C2 outputs a pixel signal read from the B pixel in the pixel row L2 to the vertical signal line 51-1. The pixel cell 35-12 in the pixel columns C3 and C4 outputs a pixel signal read from the Gb pixel in the pixel row L2 to the vertical signal line 51-2.

The pixel cell 35-21 in the pixel columns C1 and C2 outputs a pixel signal read from the Gr pixel in the pixel row L3 to the vertical signal line 52-1. The pixel cell 35-22 in the pixel columns C3 and C4 outputs a pixel signal read from the R pixel in the pixel row L3 to the vertical signal line 52-2.

The pixel signals transmitted through the vertical signal lines 51-1, 52-1, 51-2, and 52-2 are respectively input into the processing circuits 24-1, 24-2, 24-3, and 24-4. The processing circuits 24-1 to 24-4 sequentially output the processed pixel signals, in response to selective scanning by the column scanning circuit 17 in a horizontal read period T1. Signal components B2, Gr3, Gb2, and R3 read in the horizontal read period T1 correspond to pixel signals respectively detected by the B, Gr, Gb, and R pixels denoted with “1” in FIG. 22.

Then, the row scanning circuit 14 simultaneously supplies a drive signal to two pixel rows L6 and L7. The pixel row L6 is a first pixel row. The pixel row L7 is a second pixel row. The row scanning circuit 14 does not supply a drive signal to either of pixel rows L5 and L8 to be treated as thinning targets.

In a horizontal read period T2, the image sensor 10 outputs an image signal containing signal components B6, Gr7, Gb6, and R7. These signal components correspond to pixel signals respectively detected by the B, Gr, Gb, and R pixels denoted with “2” in the pixel cells 35-31, 35-41, 35-32, and 35-42 shown in FIG. 22.

The arrangement conversion part 20 rearranges the signal components B2, Gr3, Gb2, and R3 read in the horizontal read period T1 into the order of B2, Gb2, Gr3, and R3, in accordance with the order rule. The arrangement conversion part 20 rearranges the signal components B6, Gr7, Gb6, and R7 read in the horizontal read period T2 into the order of B6, Gb6, Gr7, and R7, in accordance with the order rule.

The color phase conversion part 42 generates a Gr signal component (Gr2′), an R signal component (R2′), a B signal component (B3′), and a Gb signal component (Gb3′) respectively for regions where the signal components B2, Gb2, Gr3, and R3 have been obtained. The color phase conversion part 42 generates a Gr signal component (Gr6′), an R signal component (R6′), a B signal component (B7′), and a Gb signal component (Gb7′) respectively for regions where the signal components B6, Gb6, Gr7, and R7 have been obtained.

By performing the color phase conversion, the color phase conversion part 42 obtains an image signal in which components derived from respective pixels for detecting light of colors different from each other are in a state arranged in a predetermined arrangement order. Consequently, the camera system 1 can perform a demosaic process to signal components set in a constant arrangement order, by processing means, such as the ISP 6, subsequent to the solid-state imaging device 40.

Also for the remaining pixel rows following the pixel rows L2, L3, L6, and L7, the solid-state imaging device 40 performs the same operation as performed for the pixel rows L2, L3, L6, and L7. The row scanning circuit 14 simultaneously selects one first pixel row and one second pixel row.

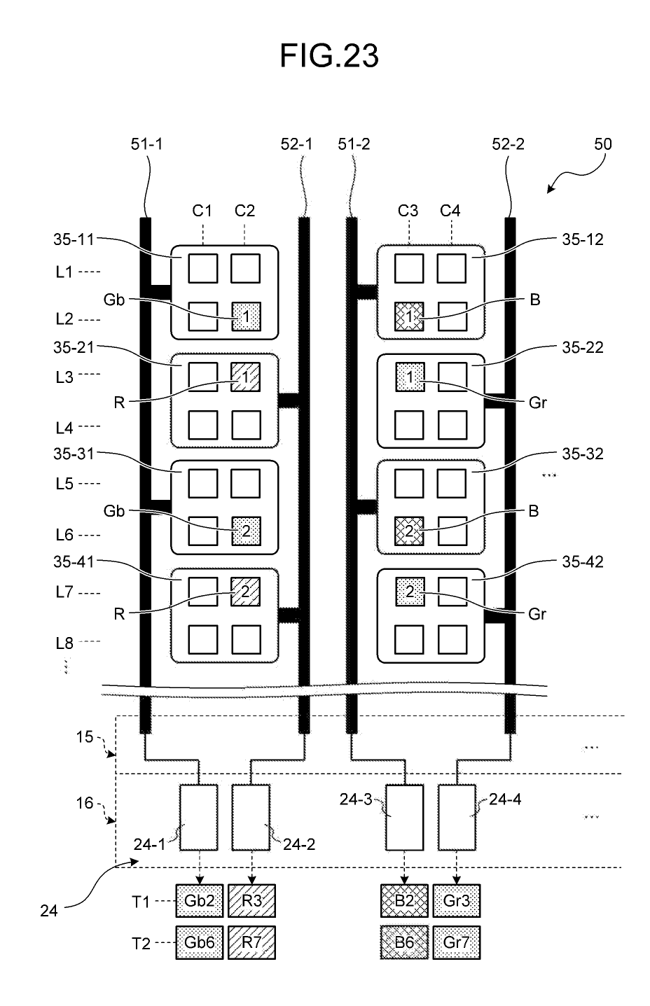

FIG. 23 is a view for explaining an operation of the solid-state imaging device in the second frame period shown in FIG. 21. At first in the second frame period F2, the row scanning circuit 14 simultaneously supplies a drive signal to two pixel rows L2 and L3. The row scanning circuit 14 does not supply a drive signal to either of pixel rows L1 and L4 to be treated as thinning targets.

The row scanning circuit 14 performs row scanning to the pixels in the pixel rows L2 and L3, to read pixel signals respectively from the pixels corresponding to the pixel column C2 and the pixels corresponding to the pixel column C3. Also for the remaining pixel columns following the pixel columns C2 and C3, the row scanning circuit 14 performs the row scanning to read pixel signals, at intervals of two pixel columns.

In a horizontal read period T1, the image sensor 10 outputs an image signal containing signal components Gb2, R3, B2, and Gr3. These signal components correspond to pixel signals respectively detected by the Gb, R, B, and Gr pixels denoted with “1” in the pixel cells 35-11, 35-21, 35-12, and 35-22 shown in FIG. 23.

Then, the row scanning circuit 14 simultaneously supplies a drive signal to two pixel rows L6 and L7. The row scanning circuit 14 does not supply a drive signal to either of pixel rows L5 and L8 to be treated as thinning targets. In a horizontal read period T2, the image sensor 10 outputs an image signal containing signal components Gb6, R7, B6, and Gr7. These signal components correspond to pixel signals respectively detected by the Gb, R, B, and Gr pixels denoted with “2” in the pixel cells 35-31, 35-41, 35-32, and 35-42 shown in FIG. 23.

The arrangement conversion part 20 rearranges the signal components Gb2, R3, B2, and Gr3 read in the horizontal read period T1 into the order of Gb2, B2, R3, and Gr3, in accordance with the order rule. The arrangement conversion part 20 rearranges the signal components Gb6, R7, B6, and Gr7 read in the horizontal read period T2 into the order of Gb6, B6, R7, and Gr7, in accordance with the order rule.

The color phase conversion part 42 generates a Gr signal component (Gr2′), an R signal component (R2′), a B signal component (B3′), and a Gb signal component (Gb3′) respectively for regions where the signal components Gb2, B2, R3, and Gr3 have been obtained. The color phase conversion part 42 generates a Gr signal component (Gr6′), an R signal component (R6′), a B signal component (B7′), and a Gb signal component (Gb7′) respectively for regions where the signal components Gb6, B6, R7, and Gr7 have been obtained.

Also for the remaining pixel rows following the pixel rows L2, L3, L6, and L7, the solid-state imaging device 40 performs the same operation as performed for the pixel rows L2, L3, L6, and L7. The row scanning circuit 14 simultaneously selects one first pixel row and one second pixel row.

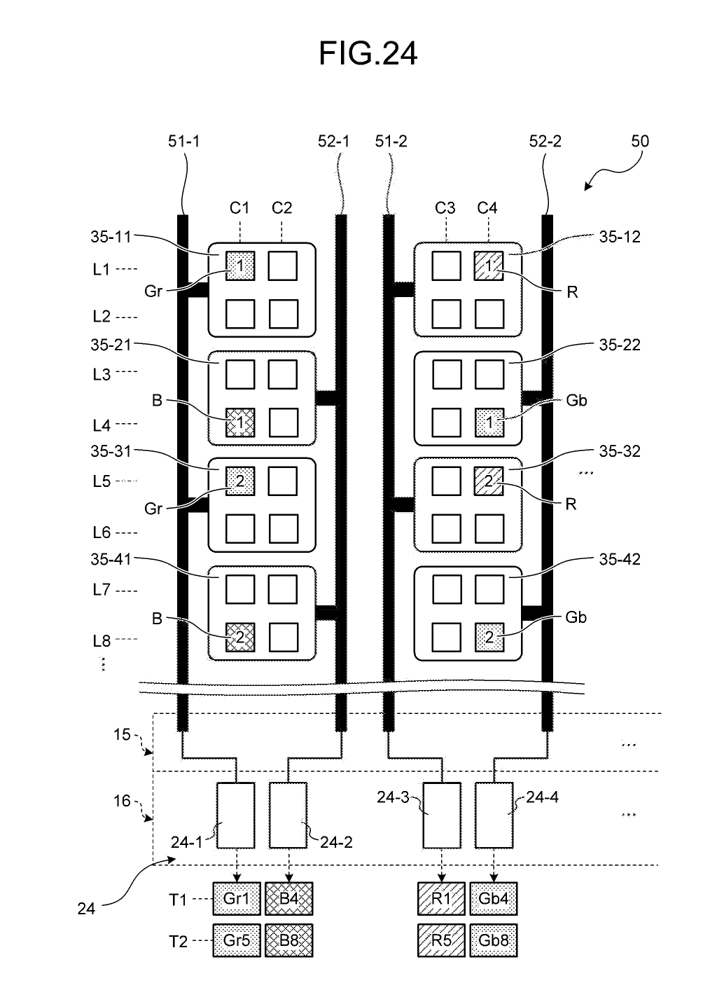

FIG. 24 is a view for explaining an operation of the solid-state imaging device in the third frame period shown in FIG. 21. At first in the third frame period F3, the row scanning circuit 14 simultaneously supplies a drive signal to two pixel rows L1 and L4. The pixel row L1 is a first pixel row. The pixel row L4 is a second pixel row. The row scanning circuit 14 does not supply a drive signal to either of pixel rows L2 and L3 to be treated as thinning targets.

The row scanning circuit 14 performs row scanning to the pixels in the pixel rows L1 and L4, to read pixel signals respectively from the pixels corresponding to the pixel column C1 and the pixels corresponding to the pixel column C4. Also for the remaining pixel columns following the pixel columns C1 and C4, the row scanning circuit 14 performs the row scanning to read pixel signals, at intervals of two pixel columns.

In a horizontal read period T1, the image sensor 10 outputs an image signal containing signal components Gr1, B4, R1, and Gb4. These signal components correspond to pixel signals respectively detected by the Gr, B, R, and Gb pixels denoted with “1” in the pixel cells 35-11, 35-21, 35-12, and 35-22 shown in FIG. 24.

Then, the row scanning circuit 14 simultaneously supplies a drive signal to two pixel rows L5 and L8. The row scanning circuit 14 does not supply a drive signal to either of pixel rows L6 and L7 to be treated as thinning targets. In a horizontal read period T2, the image sensor 10 outputs an image signal containing signal components Gr5, B8, R5, and Gb8. These signal components correspond to pixel signals respectively detected by the Gr, B, R, and Gb pixels denoted with “2” in the pixel cells 35-31, 35-41, 35-32, and 35-42 shown in FIG. 24.

The arrangement conversion part 20 rearranges the signal components Gr1, B4, R1, and Gb4 read in the horizontal read period T1 into the order of Gr1, R1, B4, and Gb4, in accordance with the order rule. The arrangement conversion part 20 rearranges the signal components Gr5, B8, R5, and Gb8 read in the horizontal read period T2 into the order of Gr5, R5, B8, and Gb8, in accordance with the order rule.

The four signal components Gr1, R1, B4, and Gb4 contained in the image signal from the arrangement conversion part 20 form a unit of the Bayer array. These four signal components are in a state arranged in the standard arrangement order described above. The four signal components Gr5, R5, B8, and Gb8 are also in a state arranged in the standard arrangement order. In the third frame period F3, the signal components of the Bayer array are in a state arranged in the standard arrangement order, and thus the color phase conversion part 42 does not perform the color phase conversion.

Also for the remaining pixel rows following the pixel rows L1, L4, L5, and L8, the solid-state imaging device 40 performs the same operation as performed for the pixel rows L1, L4, L5, and L8. The row scanning circuit 14 simultaneously selects one first pixel row and one second pixel row.

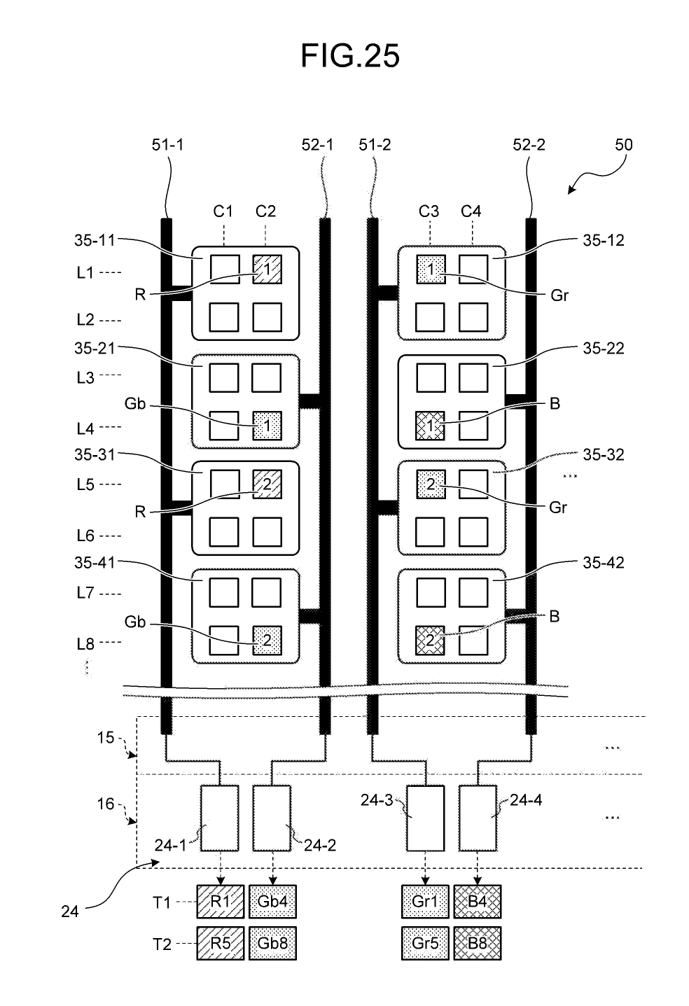

FIG. 25 is a view for explaining an operation of the solid-state imaging device in the fourth frame period shown in FIG. 21. At first in the fourth frame period F4, the row scanning circuit 14 simultaneously supplies a drive signal to two pixel rows L1 and L4. The row scanning circuit 14 does not supply a drive signal to either of pixel rows L2 and L3 to be treated as thinning targets.

The row scanning circuit 14 performs row scanning to the pixels in the pixel rows L1 and L4, to read pixel signals respectively from the pixels corresponding to the pixel column C2 and the pixels corresponding to the pixel column C3. Also for the remaining pixel columns following the pixel columns C2 and C3, the row scanning circuit 14 performs the row scanning to read pixel signals, at intervals of two pixel columns.

In a horizontal read period T1, the image sensor 10 outputs an image signal containing signal components R1, Gb4, Gr1, and B4. These signal components correspond to pixel signals respectively detected by the R, Gb, Gr, and B pixels denoted with “1” in the pixel cells 35-11, 35-21, 35-12, and 35-22 shown in FIG. 25.

Then, the row scanning circuit 14 simultaneously supplies a drive signal to two pixel rows L5 and L8. The row scanning circuit 14 does not supply a drive signal to either of pixel rows L6 and L7 to be treated as thinning targets. In a horizontal read period T2, the image sensor 10 outputs an image signal containing signal components R5, Gb8, Gr5, and B8. These signal components correspond to pixel signals respectively detected by the R, Gb, Gr, and B pixels denoted with “2” in the pixel cells 35-31, 35-41, 35-32, and 35-42 shown in FIG. 25.

The arrangement conversion part 20 rearranges the signal components R1, Gb4, Gr1, and B4 read in the horizontal read period T1 into the order of R1, Gr1, Gb4, and B4, in accordance with the order rule. The arrangement conversion part 20 rearranges the signal components R5, Gb8, Gr5, and B8 read in the horizontal read period T2 into the order of R5, Gr5, Gb8, and B8, in accordance with the order rule.

The color phase conversion part 42 generates a Gr signal component (Gr1′), an R signal component (R1′), a B signal component (B4′), and a Gb signal component (Gb4′) respectively for regions where the signal components R1, Gr1, Gb4, and B4 have been obtained. The color phase conversion part 42 generates a Gr signal component (Gr5′), an R signal component (R5′), a B signal component (B8′), and a Gb signal component (Gb8′) respectively for regions where the signal components R5, Gr5, Gb8, and B8 have been obtained.

Also for the remaining pixel rows following the pixel rows L1, L4, L5, and L8, the solid-state imaging device 40 performs the same operation as performed for the pixel rows L1, L4, L5, and L8. The row scanning circuit 14 simultaneously selects one first pixel row and one second pixel row.

The solid-state imaging device 40 performs thinning to skip two of four pixel columns in the row direction and two of four pixel rows in the column direction, when reading an image signal. The solid-state imaging device 40 performs the thinning process, and thereby reduces the data amount of an image signal in half, in each of the column direction and the row direction.

By reducing the data amount of each image signal read from the image sensor 10, the solid-state imaging device 40 can perform high-speed imaging. The solid-state imaging device 40 can prevent the sense of resolution from lowering, as compared with a case where data amount reduction equivalent to this embodiment is performed by use of thinning only on the pixel rows. The solid-state imaging device 40 can prevent jaggies from being generated, when imaging a motion picture. The solid-state imaging device 40 can prevent the image quality from deteriorating.

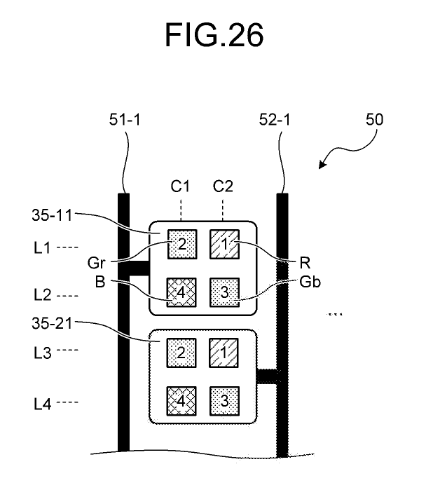

FIG. 26 is a view for explaining an operation of the solid-state imaging device in the second imaging mode according to the fourth embodiment. In the second imaging mode, the solid-state imaging device 40 does not perform the thinning process, but sequentially reads signal components from the respective pixels of the pixel array 50.

In the fourth embodiment, the solid-state imaging device 40 can read signals from the two pixels arrayed in the row direction in each pixel cell 35 at timings different from each other. For example, in the solid-state imaging device 40, two pixel drive lines are provided for each pixel row. The solid-state imaging device 40 uses the two pixel drive lines to read signals from the two pixels arrayed in the row direction at different timings.

At the first timing in a frame period, the row scanning circuit 14 simultaneously selects two pixel rows L1 and L3. The pixel cell 35-11 positioned in the pixel columns C1 and C2 sequentially outputs a pixel signal from the R pixel and a pixel signal from the Gr pixel to the vertical signal line 51-1. The pixel cell 35-21 sequentially outputs a pixel signal from the R pixel and a pixel signal from the Gr pixel to a vertical signal line 52-1. The remaining pixel cells 35 following the pixel columns C1 and C2 also output pixel signals, in the same way as in the pixel cells 35-11 and 35-21.

Then, the row scanning circuit 14 simultaneously selects two pixel rows L2 and L4. The pixel cell 35-11 sequentially outputs a pixel signal from the Gb pixel and a pixel signal from the B pixel to the vertical signal line 51-1. The pixel cell 35-21 sequentially outputs a pixel signal from the Gb pixel and a pixel signal from the B pixel to the vertical signal line 52-1. The remaining pixel cells 35 following the pixel columns C1 and C2 also output pixel signals, in the same way as in the pixel cells 35-11 and 35-21. Also for the remaining pixel rows following the pixel rows L1 to L4, the solid-state imaging device 40 performs the same operation as performed for the pixel rows L1 to L4.

In the fourth embodiment, the row scanning circuit 14 may be designed to select pixel rows one by one in a third imaging mode other than the first and second imaging modes. In the third imaging mode, the solid-state imaging device 40 sequentially reads pixel signals in the order of the pixel rows L1, L2, - - - .

The solid-state imaging device 40 may be designed such that the light exposure time for each frame in the first imaging mode is set longer than the light exposure time in the second imaging mode, as in the third embodiment. Consequently, the solid-state imaging device 40 can obtain a bright image even in a low luminance environment. If the light exposure time in the first imaging mode is set not to exceed four times the light exposure time in the second imaging mode, the solid-state imaging device 40 can set the frame rate of the first imaging mode to be equal to or larger than the frame rate of the second imaging mode.

The solid-state imaging device 40 may be designed such that the continuous four frame periods include frame periods having light exposure times different from each other, as in the third embodiment. The solid-state imaging device 40 can realize high dynamic range synthesis by use of the frame of a longer light exposure time and the frame of a shorter light exposure time. Consequently, the solid-state imaging device 40 can obtain a clear image over a wide luminance range. If the light exposure time of at least one of a plurality of frame periods in the first imaging mode is set longer than the light exposure time in the second imaging mode, the solid-state imaging device 40 can obtain a bright and clear image.

The camera system 1 may be designed such that the respective signal components of an image signal can be recognized, as to which color pixel each signal component corresponds to, by a demosaic processing means (not shown) provided at the post stage. By performing a process in accordance with the arrangement of signal components of the respective colors, the demosaic processing means can perform an accurate demosaic process, regardless of the signal component order. In this case, the solid-state imaging device 40 may omit the color phase conversion part 42.

According to the fourth embodiment, the solid-state imaging device 40 simultaneously performs read of a pixel signal from a first pixel cell through the first signal line and read of a pixel signal from a second pixel cell through the second signal line. The solid-state imaging device 40 can perform high-speed imaging by use of the simultaneous read of pixel signals and the thinning process. The solid-state imaging device 40 can perform imaging of a high-speed motion picture, and can further prevent the sensitivity from lowering and prevent the image quality from deteriorating.

### Fifth Embodiment

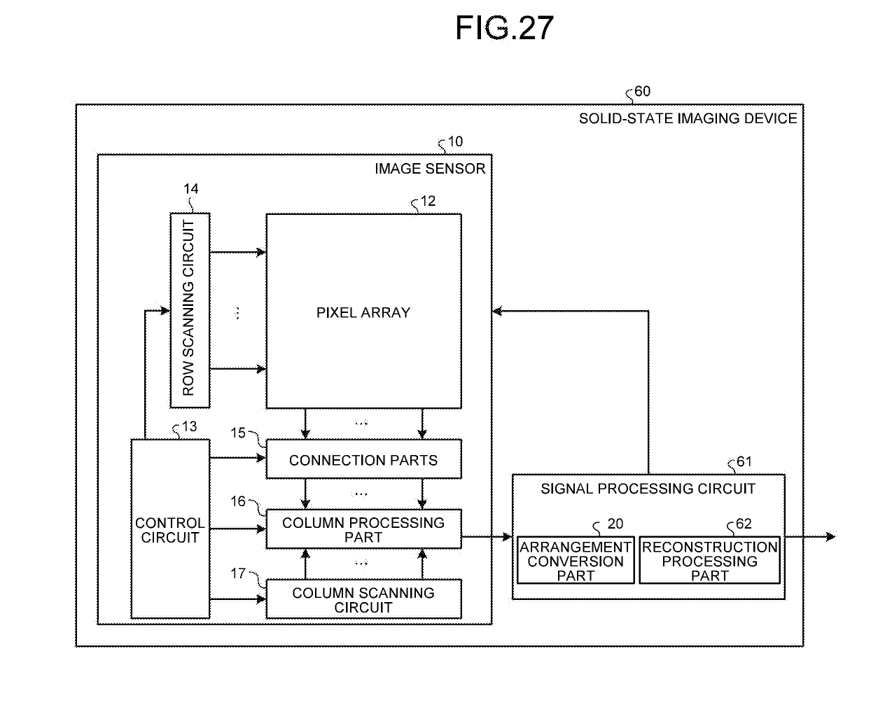

FIG. 27 is a block diagram showing a configuration of a solid-state imaging device according to a fifth embodiment. The constituent elements corresponding to those of the first embodiment described above are denoted by the same reference symbols, and their repetitive description will be suitably omitted.

The solid-state imaging device 60 according to the fifth embodiment is configured to perform read of image signals by use of first and second imaging modes the same as those used in the solid-state imaging device 5 according to the first embodiment, and to further perform read of image signals by use of a third imaging mode.

In the third imaging mode, the solid-state imaging device 60 performs a binning process similar to that of the first imaging mode according to the first embodiment. Further, in the third imaging mode, the solid-state imaging device 60 performs a thinning process that thins out the number of pixel rows to read pixel signals therefrom. The solid-state imaging device 60 sets the thinning targets of pixel rows to be different from each other between a plurality of frames.

The solid-state imaging device 60 includes an image sensor 10 and a signal processing circuit 61. The signal processing circuit 61 includes an arrangement conversion part 20 and a reconstruction processing part 62. The reconstruction processing part 62 serving as an interpolating part performs a reconstruction process for interpolating the image data of portions that have been treated as thinning targets in the third imaging mode.

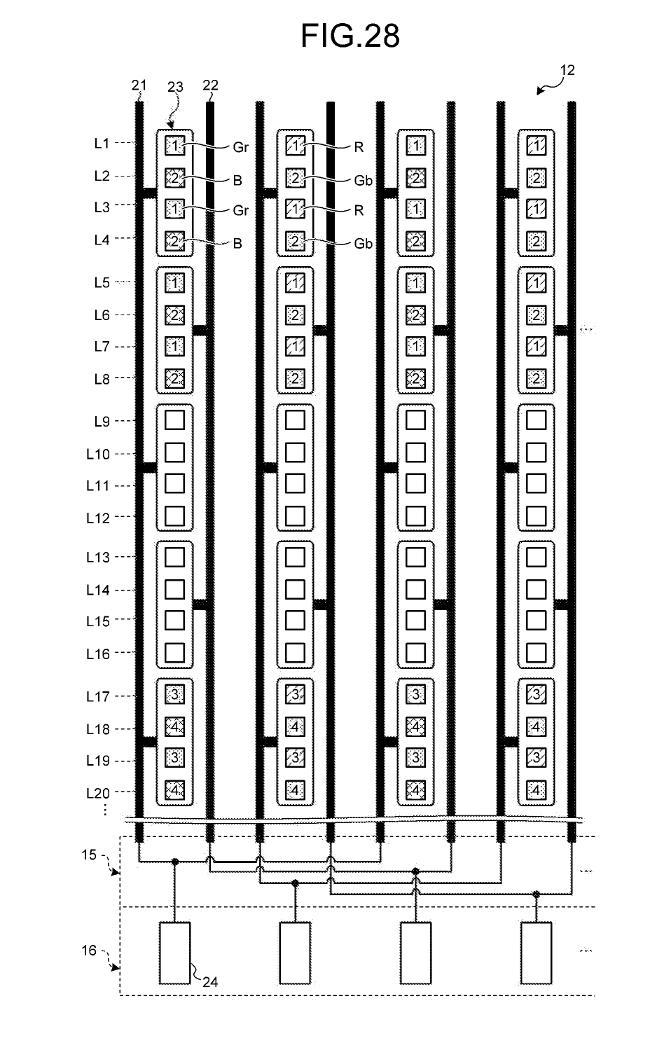

FIG. 28 is a view for explaining an operation of the solid-state imaging device in the first frame period included in the third imaging mode according to the fifth embodiment. The solid-state imaging device 60 performs 2×2 binning, as in the first imaging mode.

When a mode selection signal for setting the imaging mode to the third imaging mode is input into the control circuit 13, the control circuit 13 outputs a control signal corresponding to the third imaging mode to the connection parts 15. In response to the control signal from the control circuit 13, the connection parts 15 come into a third connection state, which is the same as the first connection state.

For pixel rows L1 to L8, the solid-state imaging device 60 performs the same operation as performed in the first imaging mode. The solid-state imaging device 60 treats eight pixel rows L9 to L16 following the pixel rows L1 to L8, as thinning targets. The solid-state imaging device 60 skips the pixel rows L9 to L16, and performs the same operation, as performed in the first imaging mode, to eight pixel rows from pixel row L17. The solid-state imaging device 60 performs read of pixel signals and skipping, at intervals of eight pixel rows.

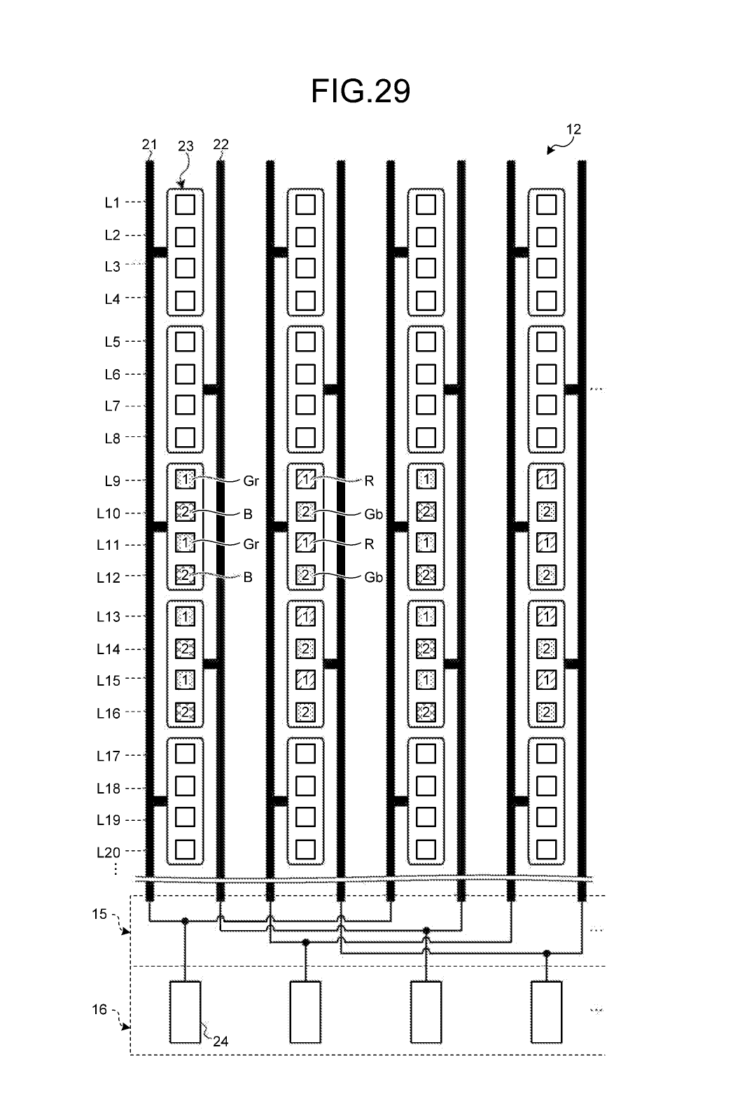

FIG. 29 is a view for explaining an operation of the solid-state imaging device in the second frame period included in the third imaging mode according to the fifth embodiment. The second frame period is a period next to the first frame period.

The solid-state imaging device 60 treats the eight pixel rows L1 to L8 as thinning targets. The solid-state imaging device 60 skips the pixel rows L1 to L8, and performs the same operation, as performed in the first imaging mode, to the pixel rows L9 to L16. The solid-state imaging device 60 skips the eight pixel rows L17 to L24 from pixel row L17, as thinning targets. The solid-state imaging device 60 performs read of pixel signals and skipping, at intervals of eight pixel rows.

In the fifth embodiment, the solid-state imaging device 60 performs the operation in the first frame period and the operation in the second frame period, alternately for respective frame periods. The solid-state imaging device 60 sets the thinning targets of pixel rows to be different from each other between the first and second frame periods.

The solid-state imaging device 60 performs the thinning process, and thereby reduces the data amount of an image signal in half, in the column direction. The solid-state imaging device 60 can set the rate of reading image signals in the third imaging mode to be theoretically two times the rate of reading image signals in the first imaging mode. By reducing the data amount of each image signal read from the image sensor 10, the solid-state imaging device 60 can perform high-speed imaging.

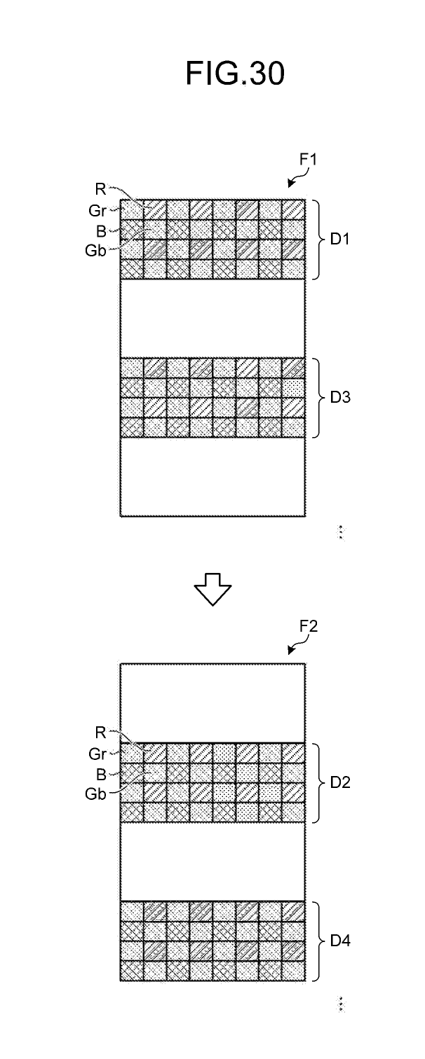

FIG. 30 is a view for explaining image data obtained by an operation of the solid-state imaging device in the third imaging mode shown in FIGS. 28 and 29. A frame F1 is a frame obtained in the first frame period. A frame F2 is a frame obtained in the second frame period. D1 to D4 denote image data obtained in respective sets of eight pixel rows.

The frame F1 contains D1 composed of the pixel signals from the pixel rows L1 to L8. The frame F1 further contains a data blank portion, which corresponds to the pixel rows L9 to L16 treated as thinning targets in the operation in the first frame period. Also in the portions from D3, an image data portion and a data blank portion are alternately juxtaposed.

The frame F2 contains D2 composed of the pixel signals from the pixel rows L9 to L16. The frame F2 further contains data blank portions, which correspond to the pixel rows L1 to L8 and L17 to L24 treated as thinning targets in the operation in the second frame period. Also in the portions from D4, an image data portion and a data blank portion are alternately juxtaposed. In the remaining frame periods following the first and second frame periods, the solid-state imaging device 60 alternately obtains data blank portions the same as those in the frame F1 and data blank portions the same as those in the frame F2.

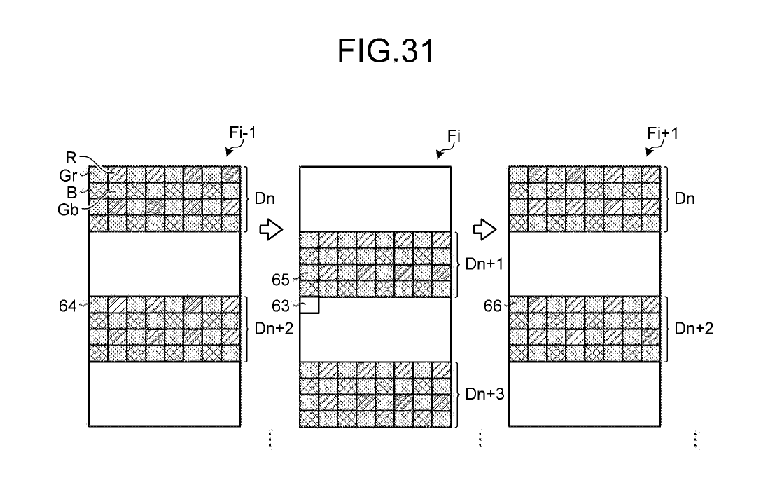

FIG. 31 is a view for explaining first to fourth methods of a reconstruction process performed by the reconstruction processing part shown in FIG. 27. It is assumed that three frames Fi−1, Fi, and Fi+1 are continuous frames. Dn to Dn+3 denote image data obtained in respective sets of eight pixel rows. Each of the frames Fi−1 and Fi+1 contains Dn and Dn+2. The frame Fi contains Dn+1 and Dn+3. The reconstruction processing part 62 may be designed to perform a reconstruction process by any one of the methods explained below.

In the first method, the reconstruction processing part 62 reconstructs image data in a frame by use of image data in this frame. For example, the reconstruction processing part 62 uses the image data Dn+1 and Dn+3 in the frame Fi to interpolate the data blank portions in the frame Fi corresponding to the image data Dn and Dn+2.

The reconstruction processing part 62 interpolates the data blank portion between the Dn+1 and Dn+3 portions by use of information contained in the Dn+1 and Dn+3. The reconstruction processing part 62 may be designed to interpolate a data blank portion by any manner using image data in a portion adjacent to this data blank portion.

In the second method, the reconstruction processing part 62 reconstructs one frame by use of image data in two frames. For example, the reconstruction processing part 62 alternately joins image data in the frame Fi+1 and image data in the frame Fi, in the row scanning order. The reconstruction processing part 62 joins the Dn and Dn+2 in the frame Fi+1 and the Dn+1 and Dn+3 in the frame Fi, in the order of Dn, Dn+1, Dn+2, and Dn+3.

Consequently, the reconstruction processing part 62 reconstructs one frame based on the two frames Fi and Fi+1. Further, the reconstruction processing part 62 reconstructs one frame based on the two frames Fi−1 and Fi.

In the third method, the reconstruction processing part 62 reconstructs image data in one frame by an arithmetic operation using a signal value contained in one of two frames and a signal value contained in the other. Here, an explanation will be given of an example for obtaining a Gr component signal value at a certain unit region 63 in the frame Fi. The unit region 63 is included in the data blank portion between the Dn+1 and Dn+3 portions.

A unit region 64 is present in the frame Fi−1 at the same position as the unit region 63 in the frame Fi. A unit region 65 is a unit region having Gr component information and being closest to the unit region 63, within the image data portions in the frame Fi. The reconstruction processing part 62 obtains an average of the signal values of the unit regions 64 and 65. The reconstruction processing part 62 performs interpolation to the unit region 63 by use of a result of obtaining the average.

Also for the respective unit regions of the data blank portion, the reconstruction processing part 62 performs interpolation by use of results of obtaining such averages, as performed for the unit region 63. The reconstruction processing part 62 may perform interpolation to the respective unit regions of the data blank portion by use of results of obtaining weighted averages.

The reconstruction processing part 62 performs data conversion to an image data portion, along with interpolation to a data blank portion. For example, the reconstruction processing part 62 replaces the signal value of the unit region 65 with a result of obtaining a weighted average of the unit regions 64 and 65. In this way, the reconstruction processing part 62 reconstructs the one frame Fi based on the two frames Fi−1 and Fi.

In the fourth method, the reconstruction processing part 62 reconstructs a target frame based on frames before and after this reconstruction target frame. Here, again, an explanation will be given of an example for interpolating a signal value at the unit region 63.

A unit region 66 is present in the frame Fi+1 at the same position as the unit region 63 in the frame Fi. The reconstruction processing part 62 obtains an average of the signal values of the unit regions 64 and 66. The reconstruction processing part 62 performs interpolation to the unit region 63 by use of a result of obtaining an average. Also for the respective unit regions of the data blank portion, the reconstruction processing part 62 performs interpolation by use of results of obtaining such averages, as performed for the unit region 63. The reconstruction processing part 62 may perform interpolation to the unit region 63 by use of a result of obtaining a weighted average of the unit regions 63, 64, and 65.

Each of the first and third methods of a reconstruction process can reduce artifacts (image disturbance) under a situation where the object can easily cause blurring (motion blur) due to large movement of the object. When a motion blur is generated, a deterioration in the sense of resolution due to use of a signal value average can be less visible. The first and third methods are suitable for a case where the object is with large movement.

Each of the second and fourth methods of a reconstruction process can obtain a high sense of resolution under a situation where the motion blur is less generated because of small movement of the object. The second and fourth methods are suitable for a case where the object is with small movement.

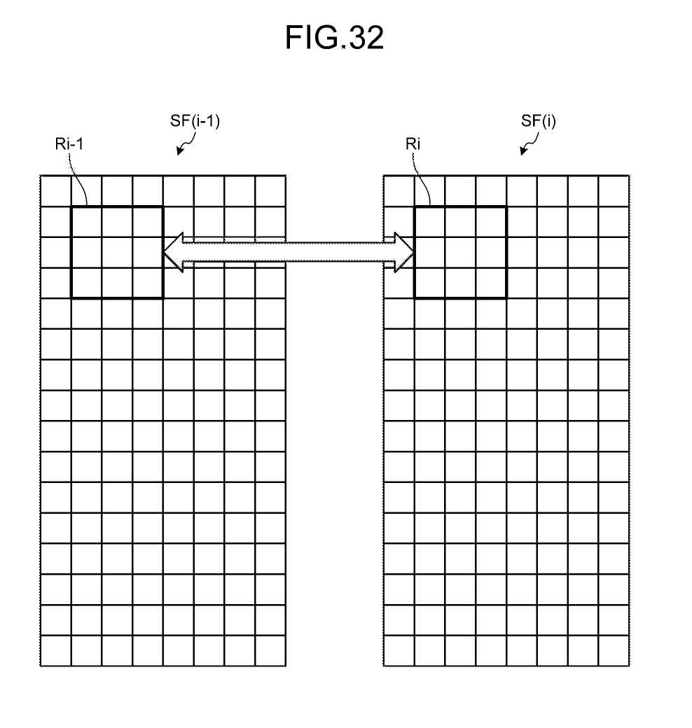

FIG. 32 is a view for explaining a fifth method of a reconstruction process performed by the reconstruction processing part shown in FIG. 27. It is assumed that frames SF(i−1) and SF(i) respectively correspond to results of reconstruction of the frames Fi−1 and Fi performed by any one of the first to fourth methods. For example, the frames SF(i−1) and SF(i) respectively correspond to results of reconstruction of the frames Fi−1 and Fi performed by the third method.

The reconstruction processing part 62 extracts the image data of a certain region Ri−1 in the frame SF(i−1). The reconstruction processing part 62 extracts the image data of a region Ri in the frame SF(i). The region Ri is present in the frame SF(i) at the same position as the region Ri−1 in the frame SF(i−1). For example, each of the regions Ri−1 and Ri is a region composed of unit regions defined by three rows and three columns.

The reconstruction processing part 62 obtains the difference in signal value between unit regions at the same position in the regions Ri−1 and Ri. The reconstruction processing part 62 calculates the sum of the absolute values of differences thus obtained (Sum of Absolute Difference; SAD).

As the SAD value is larger, it indicates that the object was with larger movement between the two frames SF(i−1) and SF(i). As the SAD value is smaller, it indicates that the object was with smaller movement between the two frames SF(i−1) and SF(i). By obtaining the SAD, the reconstruction processing part 62 estimates the degree of movement of the object.

When the SAD is larger than a first threshold value, the reconstruction processing part 62 judges that the movement of the object was large. In this case, the reconstruction processing part 62 performs a reconstruction process of the frame Fi again by the first or third method.

When the SAD is smaller than a second threshold value, the reconstruction processing part 62 judges that the movement of the object was small. In this case, the reconstruction processing part 62 performs a reconstruction process of the frame Fi again by the second or fourth method.

When the SAD is not larger than the first threshold value and not smaller than the second threshold value, the reconstruction processing part 62 obtains a result of a first reconstruction process performed by the first or third method and a result of a second reconstruction process performed by the second or fourth method. The reconstruction processing part 62 obtains a result of a third reconstruction process by mixing the results of the first and second reconstruction processes.

In accordance with the SAD calculation result, the reconstruction processing part 62 adjusts the ratio for mixing the first reconstruction result and the ratio for mixing the second reconstruction result. As the SAD value is larger, the reconstruction processing part 62 sets the ratio for mixing the first reconstruction result to be larger. Consequently, frames can be reconstructed such that the sense of resolution is given more weight as the movement of the object is smaller, and the reduction of artifacts is given more weight as the movement of the object is larger.

In this way, in the fifth method, the reconstruction processing part 62 outputs one of the first to third reconstruction results, in accordance with the SAD value.

The solid-state imaging device 60 may be designed such that the light exposure time for each frame in the third imaging mode is longer than the light exposure time in the second imaging mode, as in the third embodiment. Consequently, the solid-state imaging device 60 can obtain a bright image even in a low luminance environment. If the light exposure time in the third imaging mode is set not to exceed two times the light exposure time in the second imaging mode, the solid-state imaging device 60 can set the frame rate of the third imaging mode to be equal to or larger than the frame rate of the second imaging mode.

The solid-state imaging device 60 may be designed such that the continuous two frame periods have light exposure times different from each other. The solid-state imaging device 60 can realize high dynamic range synthesis by use of the frame of a longer light exposure time and the frame of a shorter light exposure time. Consequently, the solid-state imaging device 60 can obtain a clear image over a wide luminance range. If the light exposure time of at least one of the two frame periods is set longer, the solid-state imaging device 60 can obtain a bright and clear image.

According to the fifth embodiment, the solid-state imaging device 60 simultaneously performs read of a pixel signal from a first pixel cell through the first signal line and read of a pixel signal from a second pixel cell through the second signal line. The solid-state imaging device 60 can perform high-speed imaging by use of the simultaneous read of pixel signals and the thinning process. The solid-state imaging device 60 can perform imaging of a high-speed motion picture, and can further prevent the sensitivity from lowering and prevent the image quality from deteriorating.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array composed of pixels arrayed in a matrix format and each including a photoelectric conversion element;
a scanning circuit configured to supply a drive signal, which is for reading a pixel signal based on a signal charge accumulated in a pixel, to pixels of a selected pixel row;
signal lines configured to transmit pixel signals read in response to the drive signal;
processing circuits configured to process the transmitted pixel signals; and
connection parts configured to connect the signal lines to the processing circuits,
wherein one of the processing circuits and the signal lines including a first signal line and a second signal line are provided per one pixel column of the pixel array,
each pixel column includes first pixels configured to output pixel signals to the first signal line and second pixels configured to output pixel signals to the second signal line, and
when the scanning circuit simultaneously selects a first pixel row including the first pixels and a second pixel row including the second pixels, the connection parts connect the first signal line and the second signal line of each pixel column to processing circuits different from each other.

2. The solid-state imaging device according to claim 1, wherein, when the scanning circuit simultaneously selects the first pixel row and the second pixel row, the connection parts connect the first signal line provided for a first pixel column and the first signal line provided for a second pixel column to a first processing circuit, and connect the second signal line provided for the first pixel column and the second signal line provided for the second pixel column to a second processing circuit.

3. The solid-state imaging device according to claim 1, wherein the pixel array includes a first pixel cell including the first pixels arrayed in a column direction, and a second pixel cell including the second pixels arrayed in the column direction,
the first pixel cell is connected to the first signal line, and
the second pixel cell is connected to the second signal line.

4. The solid-state imaging device according to claim 3, wherein the scanning circuit is configured to simultaneously select a plurality of first pixel rows including the first pixels in the first pixel cell, and a plurality of second pixel rows including the second pixels in the second pixel cell.

5. The solid-state imaging device according to claim 1, wherein the pixel array includes a first pixel cell including the first pixels arrayed in a column direction and a row direction, and a second pixel cell including the second pixels arrayed in the column direction and the row direction,
the first pixel cell is connected to the first signal line, and
the second pixel cell is connected to the second signal line.

6. The solid-state imaging device according to claim 5, wherein the scanning circuit is configured to simultaneously select a plurality of first pixel rows including the first pixels in plural ones of the first pixel cells arrayed in the column direction, and a plurality of second pixel rows including the second pixels in plural ones of the second pixel cells arrayed in the column direction.

7. The solid-state imaging device according to claim 1, comprising a signal processing circuit configured to process an image signal containing, as components, the pixel signals read from the processing circuits,
wherein the signal processing circuit includes an arrangement conversion part configured to convert a component arrangement order of the image signal, in accordance with a pixel arrangement in the pixel array.

8. The solid-state imaging device according to claim 1, wherein the scanning circuit simultaneously selects the first pixel row and the second pixel row in a first imaging mode, and selects pixel rows one by one in a second imaging mode, and
in the first imaging mode, the connection parts come into a first connection state where the first signal line and the second signal line of each pixel column are connected to processing circuits different from each other, and, in the second imaging mode, the connection parts come into a second connection state different from the first connection state.

9. The solid-state imaging device according to claim 8, wherein, in the second connection state, the connection parts connect selected one of the first signal line and the second signal line of each pixel column to the processing circuits, such that
when the scanning circuit selects the first pixel row, the connection parts connect the first signal line to the processing circuits, and
when the scanning circuit selects the second pixel row, the connection parts connect the second signal line to the processing circuits.

10. The solid-state imaging device according to claim 8, wherein, in a third imaging mode, the scanning circuit stops supply of the drive signal to pixels other than pixels in the selected pixel row and pixel column, and changes at least one of pixel row selection and pixel column selection, for each cycle of a plurality of frame periods, and
in the third imaging mode, the connection parts come into a third connection state different from the first connection state and the second connection state.

11. The solid-state imaging device according to claim 10, wherein, in the third connection state, the connection parts connect selected one of two first signal lines to a first processing circuit, and connect selected one of two second signal lines to a second processing circuit, for each set of two pixel columns, such that
when the scanning circuit selects a first pixel column of the two pixel columns, the connection parts connect the first signal line, which is provided for the first pixel column, to the first processing circuit, and connect the second signal line, which is provided for the first pixel column, to the second processing circuit, and
when the scanning circuit selects a second pixel column of the two pixel columns, the connection parts connect the first signal line, which is provided for the second pixel column, to the first processing circuit, and connect the second signal line, which is provided for the second pixel column, to the second processing circuit.

12. The solid-state imaging device according to claim 10, comprising a signal processing circuit configured to process an image signal containing, as components, the pixel signals read from the processing circuits,
wherein the signal processing circuit includes a color phase conversion part configured to perform color phase conversion to the image signal obtained in each of the plurality of frame periods, to obtain the image signal in which components derived from pixels for detecting light of colors different from each other are in a state arranged in a predetermined arrangement order.

13. The solid-state imaging device according to claim 1, wherein, when simultaneously selecting the first pixel row and the second pixel row, the scanning circuit stops supply of the drive signal to pixels other than pixels in the selected pixel row and pixel column, and changes at least one of pixel row selection and pixel column selection, for each cycle of a plurality of frame periods.

14. The solid-state imaging device according to claim 13, wherein the pixel array includes a first pixel cell including the first pixels including two first pixels arrayed in a row direction, and a second pixel cell including the second pixels including two second pixels arrayed in the row direction,
the first pixel cell is connected to the first signal line, and
the second pixel cell is connected to the second signal line.

15. The solid-state imaging device according to claim 14, wherein the first signal line and the second signal line are provided for each column of the first pixel cell and the second pixel cell arrayed in a column direction, and
the connection parts are configured to connect the first signal line to a first processing circuit, and to connect the second signal line to a second processing circuit.

16. The solid-state imaging device according to claim 13, comprising a signal processing circuit configured to process an image signal containing, as components, the pixel signals read from the processing circuits,
wherein the signal processing circuit includes a color phase conversion part configured to perform color phase conversion to the image signal obtained in each of the plurality of frame periods, to obtain the image signal in which components derived from pixels for detecting light of colors different from each other are in a state arranged in a predetermined arrangement order.

17. The solid-state imaging device according to claim 13, wherein the scanning circuit stops supply of the drive signal to pixels other than pixels in the selected pixel row and pixel column in a first imaging mode, and supplies the drive signal to pixels in the pixel row and the pixel column in a second imaging mode.

18. The solid-state imaging device according to claim 8, wherein, in a third imaging mode, the scanning circuit stops supply of the drive signal to pixel rows other than selected pixel rows, and selects different pixel rows respectively for each cycle of a plurality of frame periods, and
the connection parts come into the first connection state.

19. The solid-state imaging device according to claim 18, comprising a signal processing circuit configured to process an image signal containing, as components, the pixel signals read from the processing circuits,
wherein the signal processing circuit includes an interpolating part configured to interpolate image data to which supply of the drive signal has been stopped.

20. The solid-state imaging device according to claim 10, wherein at least one of the plurality of frame periods has a light exposure time longer than a light exposure time of the second imaging mode.
